(19) United States
(12) Patent Application Publication
(10) Pub. No.: US 2026/0203592 A1
(43) Pub. Date: Jul. 16, 2026

(54) TOOL INTEGRATION FRAMEWORK FOR AGENTIC ARTIFICIAL INTELLIGENCE AND LARGE LANGUAGE MODEL REASONING

(71) Applicant: QUALCOMM Incorporated, San Diego, CA (US)

(72) Inventors: Sara RAJAEE, Amsterdam (NL); Kumar PRATIK, Amsterdam (NL); Gabriele CESA, Diemen (NL); Arash BEHBOODI, Amsterdam (NL)

(21) Appl. No.: 19/020,920

(22) Filed: Jan. 14, 2025

(51) Int. Cl. G06N 3/091

(52) U.S. Cl. CPC G06N 3/091

(57) ABSTRACT

Systems and techniques are provided for feedback-based finetuning for a large language model (LLM). An LLM can generate, based on an input query and a current solution state, a plurality of hypotheses each indicative of a candidate action to update the current solution state. A simulator can determine feedback information corresponding to a simulated outcome of applying the candidate action for each respective hypothesis to the current solution state. The plurality of hypotheses can be classified according to the feedback information into positive or negative candidate actions. A set of preference data pairs can be generated for the current solution state, each pair including a hypothesis from the positive candidate actions and a hypothesis from the negative candidate actions. A direct preference optimization (DPO) finetuned LLM can be generated using a plurality of preference data pairs including the set of preference data pairs to perform DPO finetuning of the LLM.

### FIELD

The present disclosure generally relates to implementing reasoning processes for machine learning and/or artificial intelligence models, including large language models (LLMs). For example, aspects of the present disclosure relate to systems and techniques for using a tool-in-the-loop framework to provide feedback for finetuning reasoning and agentic abilities.

### BACKGROUND

Many devices and systems allow video data to be processed and output for consumption. Digital video data includes large amounts of data to meet the demands of consumers and video providers. For example, consumers of video data desire high quality video, including high fidelity, resolutions, frame rates, and the like. As a result, the large amount of video data that is required to meet these demands places a burden on communication networks and devices that process and store the video data.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for using a tool-in-the-loop framework to provide feedback for finetuning reasoning abilities of an LLM and/or various other agentic AI models. According to at least one illustrative example, a method is provided, the method including: generating, using a large language model (LLM), a plurality of hypotheses based on an input query and information of a current solution state, wherein each respective hypothesis of the plurality of hypotheses is indicative of a candidate action to update the current solution state; determining, using a simulator associated with the LLM, feedback information for each respective hypothesis, wherein the feedback information corresponds to a simulated outcome of applying the candidate action for each respective hypothesis to the current solution state; performing classification of the plurality of hypotheses according to the feedback information for each respective hypothesis, wherein each respective hypothesis is classified into a first subset of positive candidate actions or into a second subset of negative candidate actions; generating a set of preference data pairs corresponding to the current solution state, each preference data pair including a hypothesis from the first subset of positive candidate actions and a hypothesis from the second subset of negative candidate actions; and generating a direct preference optimization (DPO) finetuned LLM based on using a plurality of preference data pairs associated with the input query to perform DPO finetuning of the LLM, wherein the plurality of preference data pairs includes the set of preference data pairs.

In another illustrative example, an apparatus is provided. The apparatus includes at least one memory and at least one processor coupled to the at least one memory and configured to: generate, using a large language model (LLM), a plurality of hypotheses based on an input query and information of a current solution state, wherein each respective hypothesis of the plurality of hypotheses is indicative of a candidate action to update the current solution state; determine, using a simulator associated with the LLM, feedback information for each respective hypothesis, wherein the feedback information corresponds to a simulated outcome of applying the candidate action for each respective hypothesis to the current solution state; perform classification of the plurality of hypotheses according to the feedback information for each respective hypothesis, wherein each respective hypothesis is classified into a first subset of positive candidate actions or into a second subset of negative candidate actions; generate a set of preference data pairs corresponding to the current solution state, each preference data pair including a hypothesis from the first subset of positive candidate actions and a hypothesis from the second subset of negative candidate actions; and generate a direct preference optimization (DPO) finetuned LLM based on using a plurality of preference data pairs associated with the input query to perform DPO finetuning of the LLM, wherein the plurality of preference data pairs includes the set of preference data pairs.

In another example, a non-transitory computer-readable medium is provided that includes instructions that, when executed by at least one processor, cause the at least one processor to: generate, using a large language model (LLM), a plurality of hypotheses based on an input query and information of a current solution state, wherein each respective hypothesis of the plurality of hypotheses is indicative of a candidate action to update the current solution state; determine, using a simulator associated with the LLM, feedback information for each respective hypothesis, wherein the feedback information corresponds to a simulated outcome of applying the candidate action for each respective hypothesis to the current solution state; perform classification of the plurality of hypotheses according to the feedback information for each respective hypothesis, wherein each respective hypothesis is classified into a first subset of positive candidate actions or into a second subset of negative candidate actions; generate a set of preference data pairs corresponding to the current solution state, each preference data pair including a hypothesis from the first subset of positive candidate actions and a hypothesis from the second subset of negative candidate actions; and generate a direct preference optimization (DPO) finetuned LLM based on using a plurality of preference data pairs associated with the input query to perform DPO finetuning of the LLM, wherein the plurality of preference data pairs includes the set of preference data pairs.

In another example, an apparatus is provided. The apparatus includes: means for generating, using a large language model (LLM), a plurality of hypotheses based on an input query and information of a current solution state, wherein each respective hypothesis of the plurality of hypotheses is indicative of a candidate action to update the current solution state; means for determining, using a simulator associated with the LLM, feedback information for each respective hypothesis, wherein the feedback information corresponds to a simulated outcome of applying the candidate action for each respective hypothesis to the current solution state; means for performing classification of the plurality of hypotheses according to the feedback information for each respective hypothesis, wherein each respective hypothesis is classified into a first subset of positive candidate actions or into a second subset of negative candidate actions; means for generating a set of preference data pairs corresponding to the current solution state, each preference data pair including a hypothesis from the first subset of positive candidate actions and a hypothesis from the second subset of negative candidate actions; and means for generating a direct preference optimization (DPO) finetuned LLM based on using a plurality of preference data pairs associated with the input query to perform DPO finetuning of the LLM, wherein the plurality of preference data pairs includes the set of preference data pairs.

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIG. 2A illustrates an example of a fully connected neural network, in accordance with some examples;

FIG. 2B illustrates an example of a locally connected neural network, in accordance with some examples;

FIG. 2C illustrates an example of a convolutional neural network, in accordance with some examples;

FIG. 3 is a diagram illustrating a question-answering language model (LM) system and a prompt-based reasoning LM system, in accordance with some examples;

FIG. 4 is a diagram illustrating an example tool integration framework for agentic artificial intelligence (AI) based on an inner reasoning interaction loop for interaction between one or more large language models (LLMs) and a simulator model, in accordance with some examples;

FIG. 5A is a diagram illustrating an example of an AI-based mathematical theorem proving system using a tool instructor for a multi-step task, in accordance with some examples;

FIG. 5B is a diagram illustrating an example of an automatic mathematical theorem proving system using a database of mathematical premises and a tactic generator for a mathematical theorem proving tool, in accordance with some examples;

FIG. 6 is a diagram illustrating an example of a system for a grounded LLM-based mathematical theorem prover configured to operate over a sequence of {state-tactic-state} triplets, in accordance with some examples;

FIG. 7 is a diagram illustrating an example of enhanced theorem proving using a simulator-in-the-loop with an LLM-based prover tool with an outer theorem proving loop and an inner tool-interaction loop, in accordance with some examples;

FIG. 8 is a diagram illustrating an example LLM-based prover tool system configured to perform data generation for offline reinforcement learning using a set of tactics generated using beam search for a reference model, in accordance with some examples;

FIG. 9 is a diagram illustrating an example system configured to perform data generation for offline reinforcement learning based on generating positive-negative pairs according to a pairing strategy, in accordance with some examples;

FIG. 10 is a diagram illustrating an example system configured to perform data generation for offline reinforcement learning and configured to perform model finetuning using a preference dataset and direct preference optimization (DPO), in accordance with some examples;

FIG. 11 is a flow chart diagram illustrating an example of a process for implementing a tool and/or simulator-in-the-loop framework to provide feedback for an LLM agent, in accordance with some examples; and

FIG. 12 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Reasoning in large language models (LLMs) can improve model performance and/or accuracy, including in examples where LLMs may increasingly be used for complex tasks that use logical inference, problem-solving, and complex decision-making. Reasoning, or reasoning capabilities and/or abilities, for an LLM may refer to the ability of an LLM to draw conclusions, make inferences, and solve problems based on one or multiple sources of available information. Early neural network architectures were, in at least some examples, primarily designed and used for pattern recognition tasks, LLMs have demonstrated increasingly sophisticated behaviors that may be seen to exhibit reasoning capabilities. For example, LLM architectures and/or models can exhibit various levels or degrees of reasoning capabilities despite not being explicitly designed as symbolic reasoning engines. In some examples, the emergent reasoning behavior(s) of various LLM models and implementations may be associated with increasing exposure of the LLM models to vast amounts of structured and unstructured data during training and/or pre-training, which can correspond to trained LLMs configured for pattern recognition that approximates logical deduction or cognitive reasoning similar to human intelligence.

In some examples, LLM and/or AI reasoning may be considered symbolic reasoning (e.g., relating to explicit and/or rule-based systems with relatively clearly defined logical steps and premises), or neural reasoning (e.g., corresponding to distributed representations and statistical correlations learned from data). LLM-based reasoning abilities may be similar to neural reasoning, and can be associated with the statistical nature of the learning processes in training the LLM(s). More complex forms of reasoning, such as formal proof generation and/or causal inference, may be more challenging to perform using LLMs without task-specific fine-tuning and/or external enhancements or augmentation.

LLMs may implement forms of reasoning based on the learned representations and attention mechanisms corresponding to the training process(es) performed for the LLMs. For example, LLMs may demonstrate internal structures that support basic logical operations and mathematical problem-solving when using appropriate datasets, training strategies, and prompting. The reasoning capabilities of LLMs may be based not only on computational power, but also on the relationships and dynamics between other factors such as the model architecture, training methodology, and information representation schema within the model's parameters. In some cases, techniques such as chain-of-thought prompting (CoT) and few-shot learning (FSL) can demonstrate that LLMs and other AI models may improve their performance in decomposing reasoning tasks when guided step-by-step through the prompting process. In some examples, LLMs and other AI models trained on datasets that more heavily emphasize or include logical structures (e.g., such as theorem proving datasets like Lean, Coq, etc., among various others) may perform more accurately in handling formal reasoning tasks and problems.

In some techniques and/or frameworks for eliciting reasoning in LLMs, the LLM-based reasoning may be based on a combination of prompting techniques or other prompt-based methods (e.g., CoT, FSL, etc.), and the use of hybrid frameworks that combined neural-based LLM models with symbolic reasoning systems, external knowledge bases, and/or retrieval-augmented generation (RAG) techniques. Generalization of LLM-based reasoning abilities can be inconsistent, for example having a strong correspondence or dependence upon prompt engineering and fine-tuning strategies more than innate model or architecture capabilities. LLMs operate through statistical associations learned during training, and LLMs can struggle with tasks that require or may benefit from access to comprehensive and up-to-date world knowledge. It may be beneficial for LLMs to implement reasoning with expanded and/or improved world knowledge access. For example, it may be beneficial for LLMs to implement reasoning that is not as strongly bounded by the information encoded within the learned parameters of the model determined during training.

Systems, apparatuses, methods (also referred to as processes), and computer-readable media (collectively referred to as “systems and techniques”) are described herein that can be used to provide a tool integration framework for agentic artificial intelligence and LLM reasoning, based at least in part on using the tool integration framework to inform LLMs with world knowledge access implemented as finetuning feedback by active and recurrent interaction between the LLM and a tool-in-the-loop and/or a simulator-in-the-loop. In some aspects, the tool or simulator-in-the-loop framework for finetuning the reasoning and agentic abilities of an LLM and/or agentic AI model can be used to ground the LLM or agentic AI model responses with simulator feedback and per-step verification corresponding to informing the model with world knowledge access for improved reasoning capabilities.

In some examples, the LLM-based reasoning framework can use a simulator-in-loop design to train, guide, and effectively enhance the reasoning and agentic abilities of foundational models. In one illustrative example, the systems and techniques can be used to implement the LLM-based reasoning framework to train, guide, and enhance the reasoning and agentic abilities of LLMS or other foundational models for solving Automatic Theorem Proving (ATP) problems, among various others. For example, the simulator-in-the-loop framework can also be referred to as a tool-in-the-loop framework (e.g., where the tool comprises one or more simulators that encapsulate and implement accumulated world knowledge within a particular one or more domains, etc.).

In some cases, the simulator tools (e.g., also referred to as simulator models) can be used as scientific world models for providing enhanced LLM-based reasoning from informing the LLM(s) with world knowledge access represented within one or more outputs, responses, actions, tactics, feedback outputs, etc., generated by the simulator tool or model in response to the simulator tool receiving as input an inference prediction or other output generated by a trained or pre-trained LLM implemented in a feedback loop for finetuning with the simulator tool. Simulator models can, in some examples, be implemented or obtained as scientific world models that are configured to encode and simulate the world knowledge access and/or human knowledge about the physical world within one or more domains.

In some cases, the simulator tool can be implemented as and/or may correspond to a neural world model. A neural world model can be obtained based on training a large foundational model to replicate physical environments which simulate interactions within the physical realm. The trained model for replicating the physical environments and/or simulating interactions within the physical realm is a neural world model. In some examples, both neural and non-neural world models can serve as physical simulator that may be used to autonomously provide feedback and guide the reasoning processes of LLMs, reducing or eliminating the need for human intervention during one or more training, re-training, fine-tuning, adaptation, etc., stages of the model deployment lifecycle.

In some cases, the systems and techniques can be configured to enhance agentic behavior of LLMs based on simulator integration with one or more LLMs with reasoning abilities (e.g., also referred to as reasoning LLMs and/or reasoning-capable LLMs, etc.). For example, one or more simulators can be integrated into the training and/or inference loops of an LLM and/or foundational models to increase the model's access and/or understanding of world knowledge, and thereby enhance (e.g., increase) the reasoning capabilities of the reasoning-capable LLMs.

In some examples, the systems and techniques can use a tool-in-the-loop technique to provide the simulator integration for finetuning and providing feedback to a reasoning-capable LLM. The reasoning-capable LLM may be pre-trained prior to being implemented in a finetuning loop with the simulator or tool model. The pre-trained and reasoning-capable LLM can then be finetuned using feedback from the simulator or tool integrated in an active and recurrent interaction loop with the LLM. For example, the LLM can be finetuned using feedback from the simulator model or framework on the tactics generated by the LLM. In some cases, the finetuning of reasoning capabilities of an LLM based on using a simulator-in-the-loop can correspond to an alignment problem, for example such as feedback-based alignment where rewards to the model during training come from either human feedback (e.g., reinforcement learning from human feedback (RLHF) training) or other reward models. RL-based strategies for feedback based alignment for LLMs and LLM reasoning may be relatively complex computationally. The systems and techniques can use direct preference optimization (DPO) and/or DPO-based techniques for training the LLM model(s).

In an illustrative example of a simulator-in-the-loop framework for training, guiding, and enhancing (e.g., finetuning) the reasoning and agentic abilities of an LLM for solving Automatic Theorem Proving (ATP) problems, a pre-trained LLM can be aligned with guidance (e.g., feedback) from interactions with a Lean theorem prover tool. Lean is an open-source, interactive theorem prover and programming language for formal verification and mathematical proof checking. Lean can be used in formal mathematics and software verification tasks, among various others, based on the relatively robust proof automation capabilities and functional programming features of Lean. For example, Lean is also a functional programming language with dependent types, similar to languages such as Coq, and can be used for both writing code and proving properties about the code. The system of dependent types used by Lean can support the expression of complex mathematical concepts directly within the language, based on using the dependent types. Lean uses a tactic framework (e.g., a tactic-based proof system), where users can apply or use different tactics (e.g., also referred to as actions) as a series of automated proof steps to construct proofs interactively.

In some examples, the systems and techniques can be configured to align a pre-trained LLM with guidance obtained from Lean. For example, the systems and techniques can obtain feedback from Lean on the generated proposals generated as output by the pre-trained LLM during a finetuning process with the Lean tool integrated in the loop with the pre-trained LLM. The systems and techniques can obtain the feedback on the generated proposals directly via an interaction with the Lean software. In some cases, the systems and techniques can perform preference optimization using direct preference optimization (DPO) and the Lean-generated feedback. In some cases, for a pre-trained LLM re-prover model, a plurality of different trajectories can be sampled during the finetuning reasoning process, where each respective trajectory of the plurality of different trajectories is a different sequence of tactics to be applied to prove a theorem. A training set used for the finetuning of the LLM with the Lean tool in the loop can include a plurality of different theorems, and a respective plurality of trajectories (e.g., different sequences of tactics) can be sampled for each theorem in the training set. Subsequently, the Lean tool can be used to determine and assign preferences to the tactics sampled for a particular state in a trajectory. Invalid tactics can be given a negative preference, while valid and/or non-invalid tactics can be given a positive preference. In some cases, valid and/or non-invalid tactics may be given a positive preference even if differing from a provided human label within the training set for proving the theorem.

Based on the finetuning technique of aligning a pre-trained LLM with feedback guidance from the Lean tool in the loop, the LLM can be trained to rank valid tactics higher than invalid tactics, including in cases where the valid tactics were not previously observed by the LLM during the training or pre-training process(es) prior to the finetuning with Lean. Based on the DPO optimization for finetuning the LLM to rank valid tactics higher than invalid tactics, a finetuned reasoning-capable LLM can be obtained, which may make more efficient use of a beam search at inference time. In some aspects, the enhanced reasoning abilities of the finetuned LLM are based on the tool/simulator-in-the-loop finetuning to leverage the feedback provided by an external tool or simulator (e.g., in this example, the Lean solver) to guide and effectively enhance the reasoning abilities of the LLM model. For example, the enhanced reasoning of the finetuned LLM from the Lean solver feedback emerges from the inference-time computes as the finetuned LLM model suggests more relevant tactics to explore (e.g., preference of valid tactics learned based on the feedback from Lean solver during finetuning).

Various aspects of the present disclosure will be described with respect to the figures.

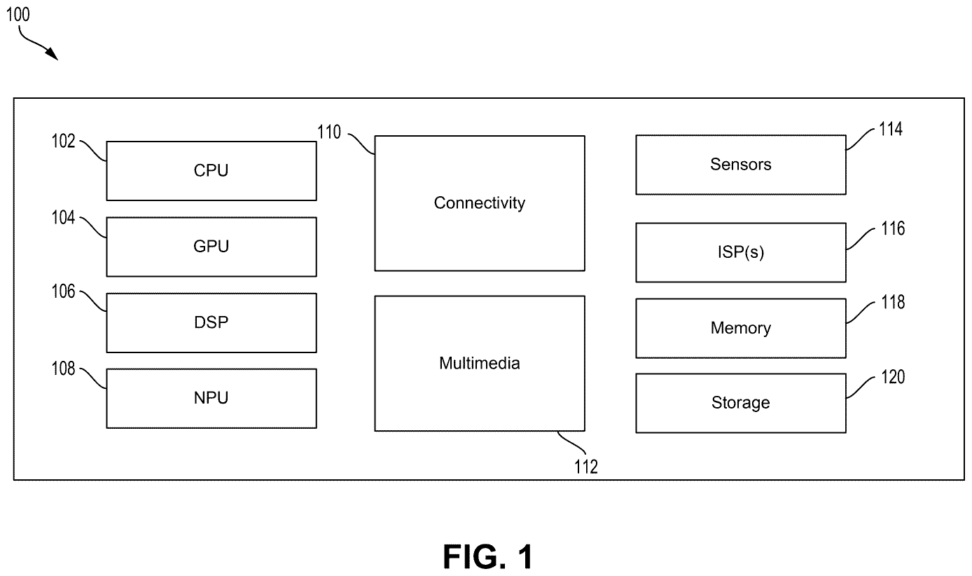

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

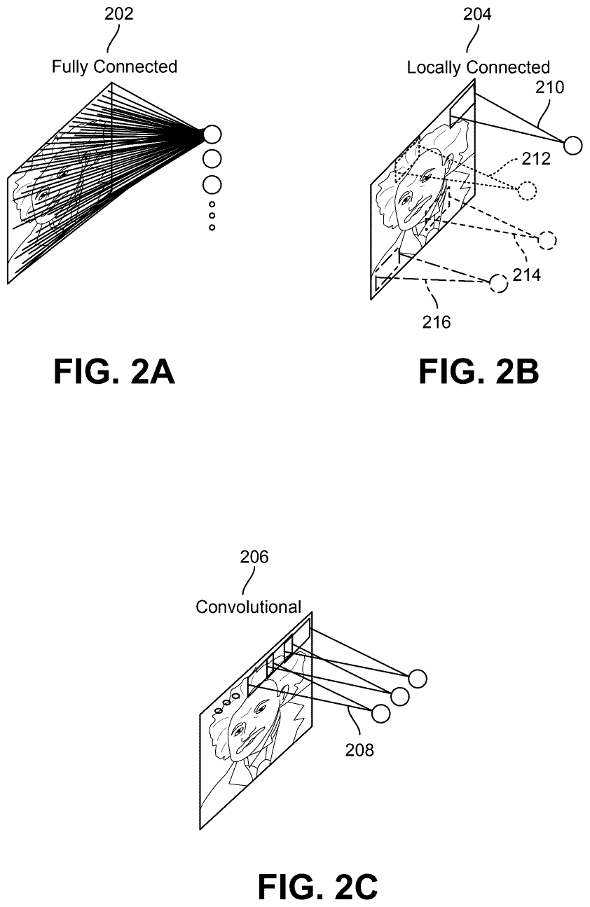

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

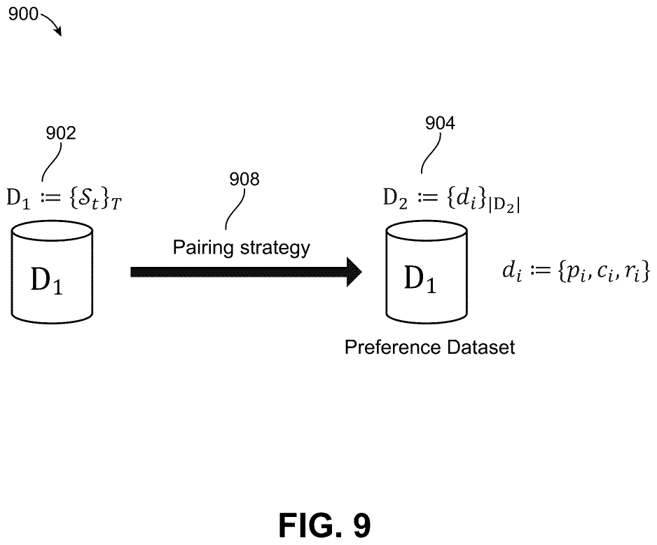

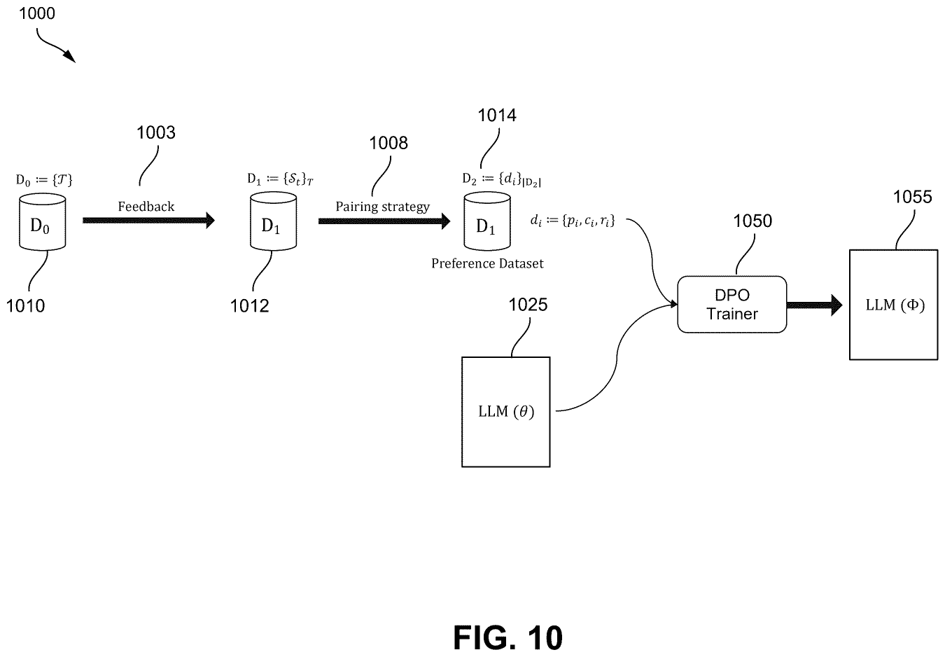

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 9. Illustrative examples of convolutional neural networks are described in greater depth with respect to the example block diagrams of FIGS. 10-12.

As noted above, LLM-based reasoning may be restricted based on the LLM being associated with one or more gaps in world knowledge access. The systems and techniques described herein can be used to provide a tool integration framework for agentic artificial intelligence and LLM reasoning, based at least in part on using the tool integration framework to inform LLMs with world knowledge access implemented as finetuning feedback by active and recurrent interaction between the LLM and a tool-in-the-loop and/or a simulator-in-the-loop. In some aspects, the tool or simulator-in-the-loop framework for finetuning the reasoning and agentic abilities of an LLM and/or agentic AI model can be used to ground the LLM or agentic AI model responses with simulator feedback and per-step verification corresponding to informing the model with world knowledge access for improved reasoning capabilities.

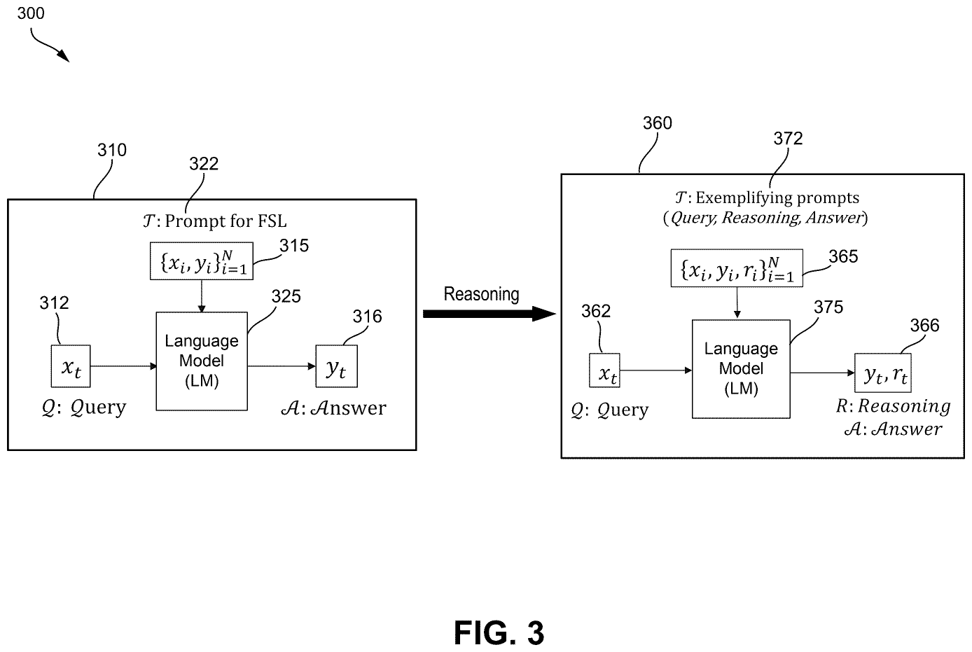

FIG. 3 is a diagram illustrating a question-answering (QA) language model (LM) system 300 and a prompt-based reasoning LM system 350, in accordance with some examples. In some cases, QA-based techniques for LLMs with reasoning steps may be prompt-based (e.g., prompt-induced) and trained using difficult to obtain human annotated data with intermediate reasoning steps. For example, the question-answering LM system 300 can include an LM 325 (e.g., an LLM and/or other LM machine learning model, etc.) that is configured to generate as output an inference prediction comprising an answer yₜ 316 to an input query xₜ 312 received and processed by the LM 325. As a QA LM system 300, the input query xₜ 312 may also be denoted as a query [symbol] , and the corresponding answer yₜ 316 may be denoted as an answer [symbol] .

In some examples, the QALM 325 can optionally receive one or more additional inputs 322 comprising or corresponding to prompts for few-shot learning (e.g., the FSL prompt(s) [symbol] . For example, the FSL prompt [symbol] 322 can comprise the set of example question-answer pairs

$${\{ {x}_{i} , {y}_{i} \}}_{i = 1}^{N} .$$

The FSL prompt [symbol] 322 can comprise a set of N question-answer pairs that can be used as examples of correct, expected, desired, etc., answers yᵢ to respective questions xᵢ. Based on performing FSL from the example question-answer pairs

$${\{ {x}_{i} , {y}_{i} \}}_{i = 1}^{N}$$

of the FSL prompt [symbol] 322, the QA LM 325 can generate the output prediction answer yₜ for the input question xₜ. Challenges associated with prompt-based reasoning (e.g., such as the prompt-based reasoning corresponding to the FSL prompting 322 for the QA LM 325) can include limitations associated with the relatively small scale of manually-curated data available with intermediate reasoning steps or indications thereof that can be used by the QA LM 325 to perform the FSL process. In some examples, prompt-based reasoning can demonstrate relatively accurate performance with natural language QA queries, prompts, tasks, etc., based at least in part on the loose constraints therein. Prompt-based reasoning may be relatively inaccurate and/or relatively low-performance when used for reasoning for scientific domains, which impose hard constraints that are different from the loose constraints associated with natural language QA domains.

For example, the prompt-based reasoning LM system 360 can be based on and/or similar to the QA LM system 300. In some cases, the LM 375 can be the same as or similar to the LM 325. The input query [symbol] of the prompt-based reasoning LM system 360 (e.g., the input query x, 362) may be the same as the input query [symbol] of the QA LM system 300 (e.g., the input query x, 312). The output of the LM 375 of the prompt-based reasoning LM system 360 may be the Reasoning, Answer pair [symbol] 366 (e.g., comprising a predicted answer yₜ and corresponding reasoning rₜ associated with the LM 375 predicting the answer yₜ during inference. To train the prompt-based reasoning LM system 360 and/or the LM 375, an additional input 372 of one or more exemplifying prompts may be provided to the LM 375. The set of exemplifying prompts can be denoted as the set of prompts [symbol] 372, which can include a plurality of query (e.g., xᵢ), answer (e.g., yᵢ), and reasoning (e.g., rᵢ) triplets provided as the input set of exemplifying prompts

$$𝒯 = {\{ {x}_{i} , {y}_{i} , {r}_{i} \}}_{i = 1}^{N} .$$

The reasoning information rᵢ for each of the N triplets included in the input set of exemplifying prompts [symbol] 372 can be used to configure the LM 375 for various types of prompt-based reasoning, including Chain-of-Thought (CoT) reasoning, Tree-of-Thought reasoning, Skeleton-of-Thought reasoning, multi-step CoTs, Diagram-of-Thought reasoning, etc., among various others.

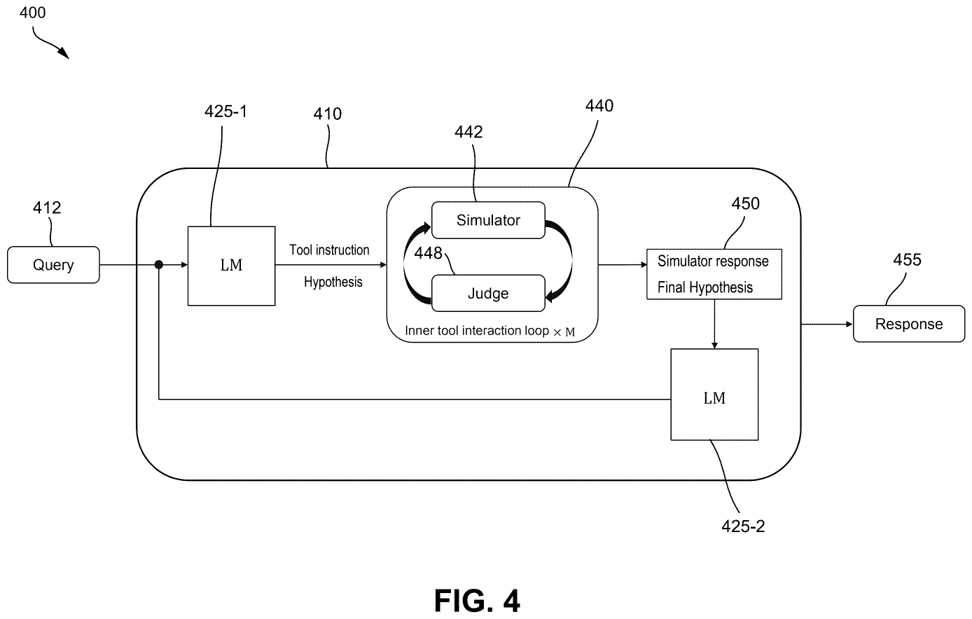

FIG. 4 is a diagram illustrating an example tool integration framework 400 for reasoning-capable LLMs, where the tool integration framework 400 includes an inner reasoning interaction loop 440 with a simulator 442 and a judge 448 for evaluating hypotheses of an LLM or other LM 425-1 against the real-world, simulated feedback of the simulation.

In one illustrative example, the inner reasoning and tool interaction loop 440 is used to enable the LLM to interact with the simulator 442 actively and recurrently, as a proxy to world knowledge encoded by or within the simulator tool 442. For example, the inner tool interaction loop can run interactively and iteratively for M iterations of the simulator-based feedback finetuning of the LLM reasoning capabilities. In some aspects, the LLM 425-1 represents the LLM being finetuned at a first time or first state t, and the LLM 425-2 represents the same LLM at the subsequent, second time or second state t+1.

For example, the LLM 425-2 at the subsequent, second time or state t+1 can comprise the LLM 425-1 from the first time or state t, updated based on the simulator response and final hypothesis 450 output from the inner tool interaction loop 440 as the simulator-based feedback to the LLM 425-1 prediction.

An outer theorem proving loop 410 can execute until the theorem (e.g., corresponding to or indicated by the input query 412 to the outer theorem proving loop 410) is proved. Based on the input query 412, the LLM 425-1 in the first state can generate a predicted response to the query 412, where the predicted response comprises a hypothesis (e.g., a hypothesized response to query 412 based on the current state and finetuning of the LLM 425-1 at t). The hypothesis can be encoded and converted into a tool instruction format that is compatible with the input requirements of a simulator tool or simulator model 442 included in the inner tool interaction loop 440. The inner tool interaction loop 440 is itself implemented in the loop of the outer theorem proving loop 410, with the LLM 425-1 at state t and the LLM 425-2 at state t+1. By encoding the hypothesis of the LLM 425-1 directly into the tool instruction prior to being input to the inner tool interaction loop 440 and simulator 442, the system 400 does not need a translation or transformation layer disposed between the output of LLM 425-1 and the input of inner tool interaction loop 440 and simulator 442.

For each iteration of the outer theorem proving loop 410 (e.g., where one iteration of the outer theorem proving loop 410 corresponds to the transition between successive states of the LLM, e.g., from state 425-1 at t to state 425-2 at t+1, etc.), the inner tool interaction loop 440 can iterate some number of times M. The simulator 442 executed and/or implements the tool instruction corresponding to the hypothesis from LLM 425-1 for the response to query 412. The inner tool interaction loop 440 includes a judge 442 that is in a circular loop with the simulator 442, where the output of simulator 442 is input to the judge 448, which generates a corresponding output that is provided to the input of simulator 442 at the next iteration of the M iterations performed by the inner tool interaction loop 440 in total. In some aspects, M corresponds to the number of multiple hypotheses under consideration (e.g., M different hypotheses included in the multiple hypotheses). The judge can be configured to interpret feedback from the simulator, to determine a positive or negative result and/or to determine a valid or invalid action for solving the theorem of the input query 412, etc.

The output of the inner tool interaction loop 440 is the simulator response and final hypothesis 450, which is used to update the state of the LLM to the next, t+1 state 425-2, before then repeating the outer theorem proving loop 410 to generate another hypothesis for query 412 and corresponding tool instruction for simulator 442 and inner tool interaction loop 440 corresponding to the t+1 state of the LLM 425-2. The outer loop 410 can be configured to loop over all possible states in episodes, so that the LLM network learns (e.g., is finetuned) to prefer actions that progress to a next stage leading towards a final output response 455 for the input query 412 (e.g., the LLM learns (e.g., is finetuned) to prefer actions that are valid based on the feedback from the simulator 442 and judge 448 of the inner tool interaction loop 440.

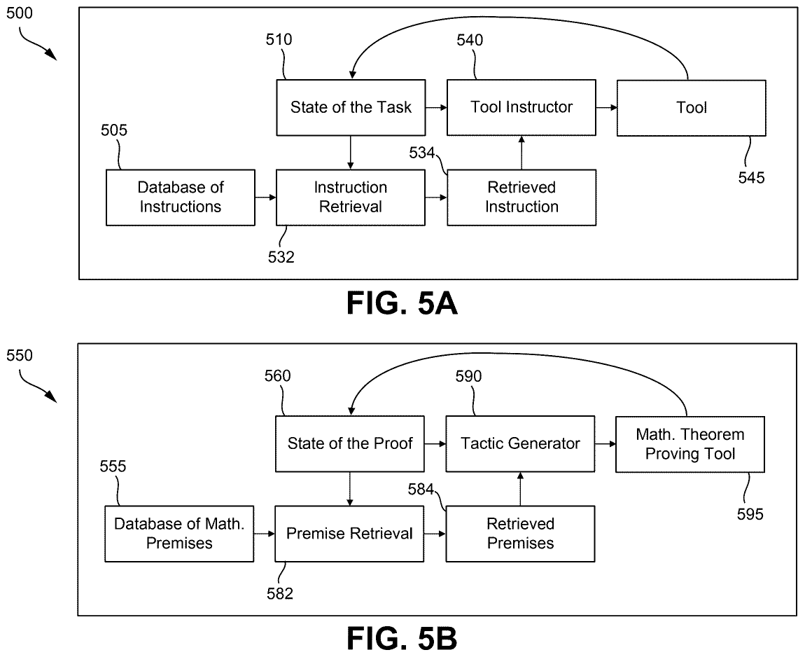

FIGS. 5A and 5B are diagrams illustrating examples of machine learning systems for automatic mathematical theorem proving in Lean using LLMs. For example, FIG. 5A is a diagram illustrating an example of an AI-based mathematical theorem proving system 500 using a tool instructor 540 for a multi-step task, in accordance with some examples. FIG. 5B is a diagram illustrating an example of an automatic mathematical theorem proving system 550 using a database of mathematical premises 555 and a tactic generator 590 for a mathematical theorem proving tool 595, in accordance with some examples.

In some examples, the mathematical theorem proving system 550 of FIG. 5B can be the same as or similar to the mathematical theorem proving system 500 of FIG. 5A. For example, the database of mathematical premises 555 can be the same as or similar to the database of instructions 505 (e.g., the mathematical premises can comprise instructions). The state of the task 510 of FIG. 5A can correspond to the state of the proof 560 of FIG. 5B. The instruction retrieval 532 of FIG. 5A can correspond to the premise retrieval 582 of FIG. 5B. The tool instructor 540 of FIG. 5A can correspond to the tactic generator 590 of FIG. 5B. The retrieved instructions 534 of FIG. 5A (e.g., obtained from the database of instructions 505 by the instruction retrieval 532) can correspond to the retrieved premises 584 of FIG. 5B (e.g., obtained from the database of mathematical premises 555 by the premise retrieval 582). The tool 545 of FIG. 5A can correspond to the mathematical theorem proving tool 595 of FIG. 5B.

In some examples, the tool 545 of FIG. 5A and/or the mathematical theorem proving tool 595 of FIG. 5B can be based on and/or can use the Lean programming language and the LeanDojo interface, which provides an interactive environment with the Lean solver (e.g., mathematical theorem proving tool 595). In some cases, the Lean solver can implement a simulator for finetuning reasoning of one or more LLMs, using the systems and techniques described herein. For example, a theorem T may be proven by an agent which iteratively observes a current proof state sₜ and interacts with the environment with a corresponding determined action aₜ.

The determined action aₜ may also be referred to as a tactic, and may comprise one or more proof steps for proving the theorem T by the agent. The selected or determined action aₜ is implanted and affects the environment, leading from the current state t to the next state t+1. The Lean solver (e.g., mathematical theorem proving tool 595, etc.) can include a dataset of mathematical premises 555 and/or a dataset of mathematical theorems for training, validation, and/or testing. For each theorem T, the dataset may include a ground truth proof P, represented in the form of a sequence of state-tactic pairs P={(sₜ, aₜ)}ₜ. The proof state sₜ₊₁ can be generated by the Lean solver starting from the previous state sₜ when the tactic aₜ is applied and the sequence of all the tactics is a complete proof of the original theorem T.

In some cases, the tool instructor 540 and/or the tactic generator 590 can be implemented based on a ReProver machine learning model, which can use pre-trained weights corresponding to a retrieval-augmented tactic generator based on a pre-trained encoder-decoder transformer model. The pre-trained encoder-decoder transformer model used to implement the tactic generator 590 can take as input the current state sₜ, augmented with a number of retrieved premises 594, and may generate as output the next tactic to try, aₜ. The tactic generator 590 machine learning model can be trained on the ground truth manually labeled proofs associated with the LeanDojo interface, the Lean solver, and/or the mathematical theorem proving tool 595, etc. The tactic generator 590 can be trained to maximize the likelihood of the ground truth manually labeled proofs. At inference time, the tactic generator model 590 can be combined with beam search techniques to sample high-likelihood proofs.

In some cases, the tactic generator 590 implements a retrieval-augmentation component using retrieval-augmented generation. At each step or state (e.g., t, t+1, etc.), the input prompt to the tactic generator model 590 includes state sₜ (e.g., the state of the proof 560) and a set of retrieved relevant premises pₜ (e.g., the retrieved premises 584), which can assist the generation of an output tactic aₜ at the current state by the tactic generator 590. In some cases, premises can be lemmas or definitions that may be used in proving a theorem. Premises can be directly passed as arguments of one or more tactics.

Premises can be included inside math libraries. In some cases, the tactic generator 590 can use a separate model for performing the premise retrieval (e.g., premise retrieval 582 can be implemented using a separate model to retrieve the most relevant premises for a given state sₜ from a database of mathematical premises 555). In some examples, the premise retriever 582 can be a encoder-only architecture trained separately from the tactic generator 590.

In some aspects, the tactic generator machine learning model 590 can be trained using imitation learning on a fixed set of manually labeled trajectories (e.g., existing proofs from math libraries, etc.). In one illustrative example, the systems and techniques can be configured to finetune a pre-trained tactic generator model using the feedback obtained from the Lean solver (e.g., the mathematical theorem proving tool 595). For example, the feedback from the Lean solver (e.g., mathematical theorem proving tool 595) can be used to verify the validity of the proof steps generated as the predicted output actions at inference time by the tactic generator model 590.

For a pre-trained model used to parameterize a reference base policy π_{ref} (e.g., in some cases, the same model being finetuned), and a static dataset of human preferences comprising pairwise comparisons

$$D = {\{ ( {x}_{i} , {y}_{i}^{+} , {y}_{i}^{-} ) \}}_{i} with {y}_{i}^{*} ∼ {π}_{ref} ( {y}_{i} \vert {x}_{i} ) ,$$

such that for each prompt xᵢ, the generated output

$${y}_{i}^{+}$$

is preferred over output

$${y}_{i}^{-} .$$

While RLHF is based on fitting a reward function on this data, and later using the fitting data to finetune the model by reinforcement learning, DPO can be implemented to directly optimize the policy π_{θ}, which in some cases is initialized to π_{ref}, using the following loss based on the static dataset:

$${L}_{DPO} ( {π}_{θ} , {π}_{ref} ) = - {𝔼}_{( x , {y}^{+} , {y}^{-} ) ∼ D} [ log σ ( β log \frac{{π}_{θ} ( {y}^{+} \vert x )}{{π}_{ref} ( {y}^{+} \vert x )} - βlog \frac{{π}_{θ} ( {y}^{-} \vert x )}{{π}_{ref} ( {y}^{-} \vert x )} ) ] \qquad Eq . ( 1 )$$

Here, σ is the logistic function. The loss of Eq. (1) can correspond to a closed-form solution of the RL problem when a Bradley-Terry reward parameterization model is adopted to optimize the loss for a similar optimal policy. To leverage the feedback from the Lean solver (e.g., mathematical theorem proving tool 595) for finetuning using DPO, a pre-trained tactic generator 590 can be implemented as a pre-trained ReProver model both as a base reference model for π_{ref} and to initialize the policy to optimize π_{θ}. A model π can take the current proof state sₜ (e.g., state of the proof 560) and the associated retrieved premises pₜ (e.g., retrieved premises 584) as an input prompt x=(sₜ, pₜ) and can sample multiple outputs that are interpreted as tactics

$${A}_{t} = {\{ {a}_{t}^{j} = {y}^{j} ∼ π ( ( y \vert x = ( {s}_{t} , {p}_{t} ) ) \}}_{j} .$$

For example, mathematical theorem proving can be implemented as a sequence of {state-tactic-state} triplets. In one illustrative example, the triplets can comprise the form {stateₜ, tacticₜ, stateₜ₊₁}, where the tactics is determined at or for stateₜ and causes a transition or update from stateₜ to the next state, stateₜ₊₁. In some examples, the Lean framework can be used to write most mathematical theorem proofs as a sequence of {state, action(tactic), state} triplets as above, for example as

$$𝕋 = {\{ {s}_{i} , {a}_{i} , {s}_{i + 1} \}}_{i = 1}^{k} .$$

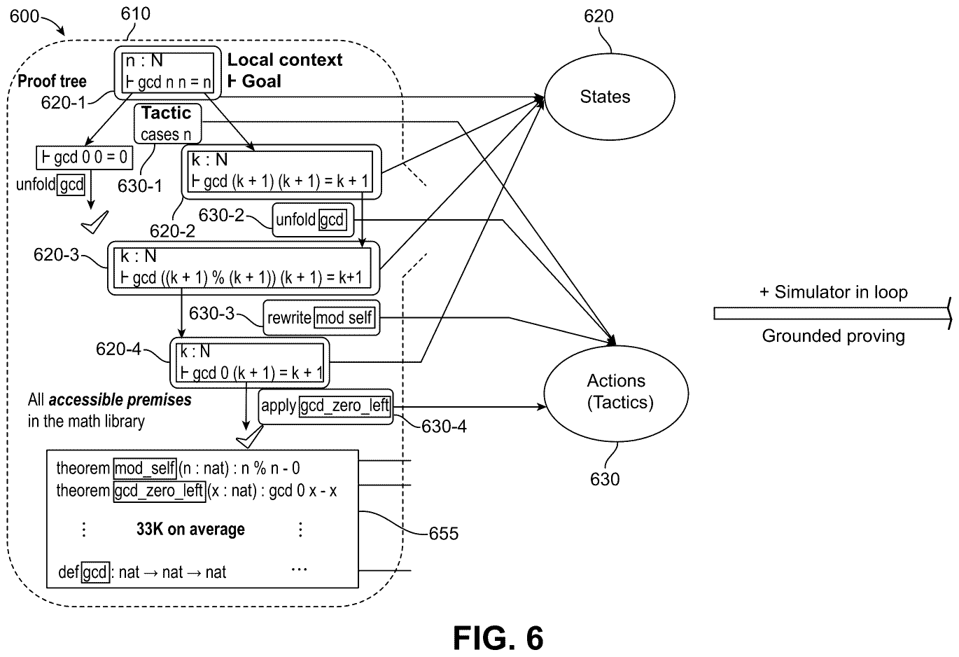

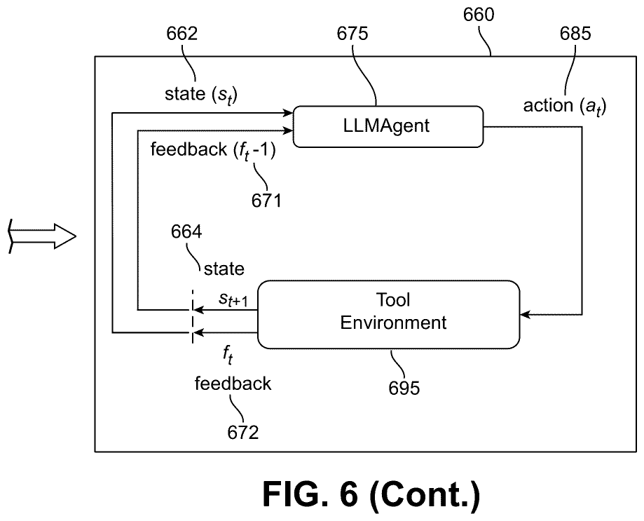

FIG. 6 is a diagram illustrating an example of a system 600 for a grounded LLM-based mathematical theorem prover configured to operate over a sequence of {state-tactic-state} triplets, in accordance with some examples. In some cases, the system includes a proof tree 610 for a Lean theorem ∀n∈ [symbol] , gcd n n=n, where gcd is the greatest common divisor. The proof tree can be generated using a simulator in loop for implementing grounded proving, corresponding to the set of states 620 (e.g., the plurality of states 620-1, 620-2, 620-3, 620-4, etc.) and the set of actions (e.g., tactics) 630 determined for updating from one state to the next (e.g., the plurality of actions 630-1, 630-2, 630-3, 630-4, etc.). The sets of states 620 and actions 630 can comprise respective triplets of the sequence of {state-tactic-state} triplets, for example as the set

$$𝕋 = {\{ {s}_{i} , {a}_{i} , {s}_{i + 1} \}}_{i = 1}^{k} .$$

A tool interaction loop 660 can be the same as or similar to the inner tool interaction loop 440 of FIG. 4, and includes an LLM agent 675 and tool environment 695. The LLM agent 675 may correspond to one or more of the LLM 425-1, 425-2 of FIG. 4 and/or the judge 448 of FIG. 4. The tool environment 695 may correspond to the simulator 442 of FIG. 4. For a current state sₜ 662 input to the LLM agent 675, the LLM agent 675 can use simulator feedback 671 fₜ₋₁ from the tool environment 695 for the previous state (e.g., state t−1) to determine an action 685 aₜ for the current state. The action 685 aₜ is output by the LLM agent 675 for the current state, and is provided as input to the tool environment 695 for simulation and judging or other evaluation. The output of the tool environment 695 for the action 685 aₜ determined by the LLM agent 675 is the feedback fₜ 672, and a next state 664 sₜ₊₁ determined by updating the state 662 sₜ according to the generated feedback 672 fₜ from the simulation information.

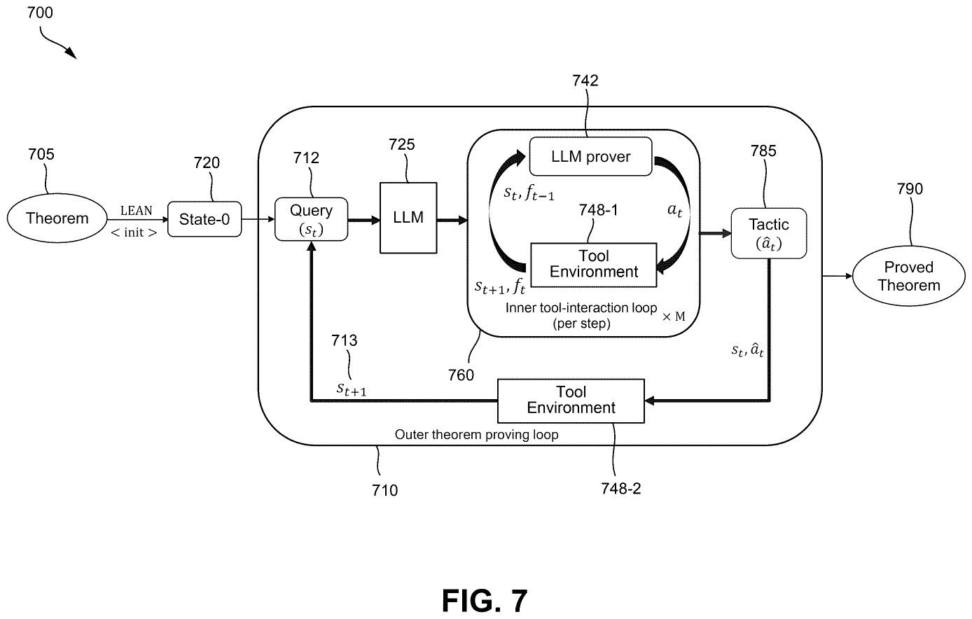

FIG. 7 is a diagram illustrating an example of a system 700 configured for enhanced theorem proving based on a simulator-in-the-loop with an LLM-based prover tool. In some aspects, the system 700 includes an outer theorem proving loop 710 configured to perform sequential interactions with the LLM prover 742 and tool environment of the inner tool interaction loop 760, until an input theorem 705 (e.g., query) is successfully proven and output as the proved theorem 790 from the outer theorem proving loop 710. In some cases, the input theorem 705 can be the same as or similar to one or more of the query 312 of FIG. 3, the query 412 of FIG. 4, etc. The theorem 705 can be used as a Lean environment initialization information for determining a first state (e.g., State-0) 720 that is provided to the outer theorem proving loop 710 as an initial query 712 for the first state (e.g., represented as the query se). The query sₜ 712 can be processed by an LLM 725 undergoing the finetuning for reasoning based on feedback from the simulator in the loop. The LLM 725 of FIG. 7 may be the same as or similar to one or more of the LM 325 and/or 375 of FIG. 3, the LM 425-1 and/or 425-2 of FIG. 4, the LLM agent 675 of FIG. 6, etc.

An inner tool interaction loop 760 includes LLM prover 742 and a tool environment 748-1. The inner tool interaction loop 760 may be the same as or similar to the inner tool interaction loop 440 of FIG. 4. The LLM prover 742 can be the same as or similar to the simulator tool 442 of FIG. 4, the tool instructor 540 of FIG. 5A, the tactic generator 590 of FIG. 5B, the LLM agent 675 of FIG. 6, etc. The tool environment 748-1 of FIG. 7 may be the same as or similar to the judge 448 of FIG. 4, the tool environment 695 of FIG. 6, etc. In some aspects, the tool environment 748-1 can be LeanDojo. The inner tool interaction loop can provide tool interaction with guidance from Lean, iterating through M different hypotheses included in a set of multiple hypotheses, for each instance of the inner tool interaction loop 742 being used by one cycle through the outer theorem proving loop 710.

The inner tool interaction loop 760 can be optimized using reinforcement learning DPO, as noted above. The output of the inner tool interaction loop 760 can be a tactic 785 âₜ, corresponding to an action or solving step for the input theorem 705 and the current query 712 state sₜ. The tactic 785 âₜ can be provided from the inner tool interaction loop 760 to a tool environment 748-2 included in the outer theorem proving loop 748-2. The tool environment 748-2 may be the same as or similar to the tool environment 748-1 of the inner tool interaction loop 760. For example, the tool environment 748-1 can be a first instance of a particular tool environment and the tool environment 748-2 can be a second instance of the particular tool environment. The tool environments 748-1 and 748-2 may have the same configurations, or may have different respective configurations.

The outer theorem proving loop 710 can use the tactic 785 âₜ at the tool environment 748-2 to implement sequential interaction with Lean using a best-first search strategy over the thought tactics output from the inner tool interaction loop 760 (e.g., thought tactics such as the tactic 785 âₜ, etc.). Based on the state sₜ and the tactic 785 âₜ, the tool environment 748-2 of the outer theorem proving loop 710 can determine the updated state 713 sₜ₊₁, which is provided as an updated input to the beginning of a new cycle of the outer theorem proving loop as the input query 712 to the LLM 725.

In some cases, the system 700 of FIG. 7 can be configured to implement alignment of the inner tool interaction loop 760 using direct preference optimization (DPO), as noted above. For example, DPO training can be performed for the inner tool interaction loop 760, where the LLM prover 742 is trained with the Lean solver tool (e.g., associated with and/or included within the tool environment 748-1) in the loop to generate feedback for finetuning the LLM prover 742 to predict as output actions or tactics 785 âₜ that are correct next steps for proving the theorem 705. In some cases, the outer theorem proving loop 710 can be configured to perform beam search for the best trajectory determination for the output of the proved theorem 790. The beam search for the best trajectory may use a best-first configuration, an MCTS configuration, etc.

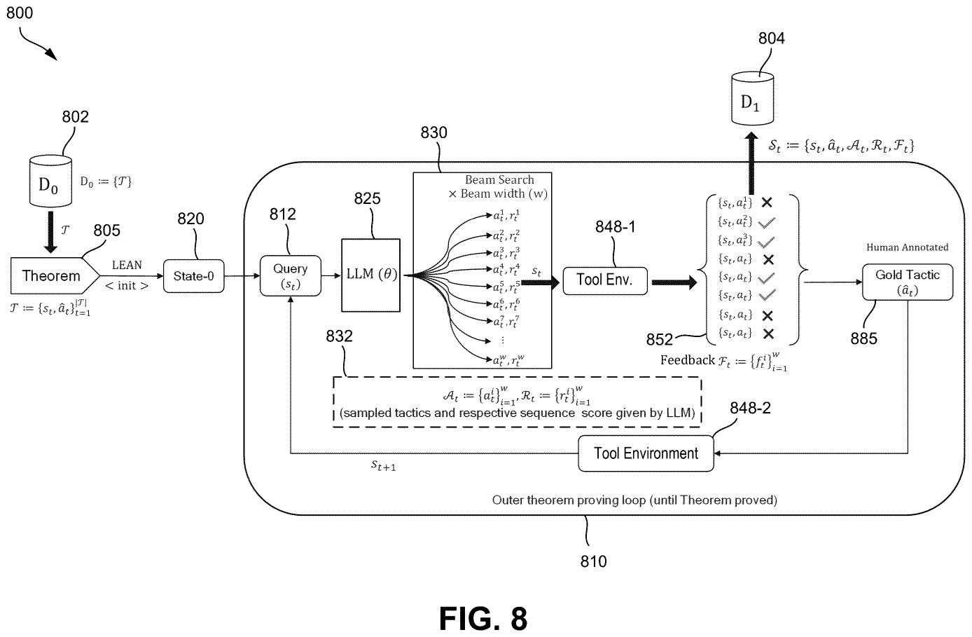

FIG. 8 is a diagram illustrating an example LLM-based prover tool system 800 configured to perform data generation for offline reinforcement learning using a set of tactics generated using beam search for a reference model, in accordance with some examples. In some cases, input theorem 805 can be the same as or similar to the input theorem 705 of FIG. 7, and the first state 820 may be the same as or similar to the first state 720 of FIG. 7. The query 812 can be the same as or similar to the query 712 of FIG. 7. The LLM 825 can correspond to the LLM 725 of FIG. 7. The tool environment 848-1 and 848-2 can correspond to the tool environment 748-1 and 748-2 of FIG. 7, respectively.

In some cases, the systems and techniques can implement dataset generation and Lean feedback for offline reinforcement learning. In a first step, the system 800 can be configured to obtain feedback from the simulator tool to perform data generation for the offline reinforcement learning. For example, a static dataset of preferences for DPO can be generated. For each proof state sₜ within each proved theorem within an original training dataset, the system can sample

$$w = 8 tactics \{ {a}_{t}^{j} \} ∼ {π}_{ref} {( a \vert {s}_{t} , {p}_{t} )}_{j}^{w}$$

using beam search 830, and may perform sorting by likelihood score according to the model. In some cases, when the ground truth tactic âₜ (e.g., the human annotated “gold” or ground truth tactic 885, etc.) for the current state sₜ is not sampled by likelihood score according to the model, it may be added as an n^{th} tactic at the end of the list (e.g., with the lowest likelihood). For example, the ground truth tactic âₜ can be appended to the end of the listing of

$$w = 8 tactics \{ {a}_{t}^{j} \} ∼ {π}_{ref} {( a \vert {s}_{t} , {p}_{t} )}_{j}^{w} ,$$

with the appended ground truth tactic âₜ comprising a new, 9^{th} tactic having the lowest likelihood of the updated listing of w=9 tactics. In some examples, the system 800 can automatically verify each respective tactic in the listing of the w tactics

$$\{ {a}_{t}^{j} \} ∼ {π}_{ref} {( a \vert {s}_{t} , {p}_{t} )}_{j}^{w} .$$

In some cases, the listing of the w tactics

$$\{ {a}_{t}^{j} \} ∼ {π}_{ref} {( a \vert {s}_{t} , {p}_{t} )}_{j}^{w}$$

can be the same as the listing of tactics 832 of FIG. 8, which comprises sampled tactics and respective sequence score values determined for each respective one of the sampled tactics by the LLM(θ) 825.

Each respective tactic of the listing of tactics 832 may be verified on its corresponding state within Lean (e.g., can be verified by the tool environment 848-1), which provides a Boolean feedback for each respective tactic, indicative of whether the respective tactic can be applied successfully (e.g., leads to a new proof state, even if the new proof state does not complete the proof) or if application of the respective tactic failed (e.g., the respective tactic was syntactically incorrect, was unable to be applied on the current state, etc.).

For example, one of the sampled tactics by the LLM(θ) 825 and/or each respective tactic of the listing of tactics 832 may be verified on its corresponding state sₜ within the tool environment 848-1, which is configured to generate (e.g., based on the verification processing) a respective feedback 852

$${ℱ}_{t} := {\{ {f}_{t}^{i} \}}_{i = 1}^{w}$$

for the tactics within the set of tactics

$${𝒜}_{t} := {\{ {a}_{t}^{i} \}}_{i = 1}^{w}$$

of the listing 832. For example, the respective feedback 852 can indicate whether each tactic (e.g., action) 832 can be applied successfully (e.g., is valid) or cannot be applied successfully (e.g., is invalid). In one illustrative example, for the listing of listing of w=8 tactics corresponding to the beam search 830 and the listing 832, the tool environment 848-1 can determine the feedback set 852 indicating that a first tactic

$${a}_{t}^{1}$$

is not valid for the current state sₜ; a second tactic

$${a}_{t}^{2}$$

is valid for the current state sₜ; a third tactic

$${a}_{t}^{3}$$

is valid for the current state sₜ; a fourth tactic

$${a}_{t}^{4}$$

is not valid for the current state sₜ; a fifth tactic

$${a}_{t}^{5}$$

is valid for the current state sₜ; a sixth tactic

$${a}_{t}^{6}$$

is valid for the current state sₜ; a seventh tactic

$${a}_{t}^{7}$$

is not valid for the current state sₜ; and an eighth tactic

$${a}_{t}^{8}$$

is not valid for the current state sₜ.

The feedback verification by the tool environment 848-1 to indicate each tactic of the listing 832 as valid or not valid within the feedback set 852 can be used to obtain a set of positive and negative preferences for each state sₜ.

A dataset of pairwise comparisons D can be generated for each state sₜ by determining pairs of tactics with positive and negative feedback. For example, DPO dataset generation of the pairwise comparisons D can be performed based on the pseudocode example provided below as Pseudocode 1:

```
Pseudocode 1: DPO dataset generation
Input: training dataset Dₜᵣₐᵢₙ, reference policy π_{ref}, retrieval model retriever
  D ← [ ]
  for theorem and g.t. proof (T, P) ∈ Dₜᵣₐᵢₙ do
    for proof state and g.t. tactic (sₜ, âₜ) ∈ P do
      pₜ ← retriever(sₜ)
      ${A}_{t} ← \{ {a}_{t}^{j} ∼ {π}_{ref} ( {a}_{t} \vert {s}_{t} , {p}_{t} ) \vert j = 1 , … , 8 \}$
      sort(Aₜ)
      if âₜ ∉ Aₜ then
        append âₜ aₜ the end of Aₜ (w = 9)
      ${A}_{t}^{+} ← \{ {a}_{t}^{j} \vert Lean ( {a}_{t}^{j} \vert {s}_{t} , T ) = + \}$
      ${A}_{t}^{-} ← \{ {a}_{t}^{j} \vert Lean ( {a}_{t}^{j} \vert {s}_{t} , T ) = - \}$
      $for {y}^{-} ∈ {A}_{t}^{-} do$
        $for {y}^{-} ∈ {A}_{t}^{+} do$
          if π_{ref}(y⁻|sₜ, pₜ) > π_{ref} (y⁺|sₜ, pₜ) then
            x ← dynamic_prompt(sₜ, pₜ)
            D.append((x, y⁺, y⁻))
            $move {y}^{+} at the end of {A}_{t}^{+} to lower its priority$
            break
Output: D
```

In some aspects, in Pseudocode 1, the operation pₜ←retriever(sₜ) can be used to compute the premises for retrieval augmentation.

The operation

$${A}_{t} ← \{ {a}_{t}^{j} ∼ {π}_{ref} ( {a}_{t} \vert {s}_{t} , {p}_{t} ) \vert j = 1 , … , 8 \}$$

can be performed with beam search using beam width w=8.

The operation sort(Aₜ) can be performed to sort by decreasing order of π_{ref}(a|sₜ, pₜ) when needed.

The operation append âₜ at the end of Aₜ (w=9) can be used to add the ground truth gold tactic 885, when needed.

The operation

$${A}_{t}^{+} ← \{ {a}_{t}^{j} \vert Lean ( {a}_{t}^{j} \vert {s}_{t} , T ) = + \}$$

can be performed to obtain Lean feedback (e.g., feedback 852 from tool environment 848-1) for each sampled tactic in the beam search 830 and tactic listing 832.

The operation x←dynamic_prompt(sₜ, pₜ) corresponds to prompt augmentation by premises dropout.

The operation “break” corresponds to exiting the inner loop over

$${A}_{t}^{+}$$

and moving to the next y⁻.

In one illustrative example, the training dataset Dₜᵣₐᵢₙ of Pseudocode 1 can be the same as the first dataset D₀ 802 of FIG. 8, where D₀{ [symbol] }. In some aspects, the output D of Pseudocode 1 is the DPO dataset, which may be the same as the dataset D₁ 804 of FIG. 8, where [symbol] :={sₜ, âₜ, [symbol] }.

In some aspects, the systems and techniques can be configured to reduce the combinations of positive and negative feedback pairs. For example, rather than considering every possible such combination (e.g., which may correspond to a very large dataset size), the system 800 can be configured to consider only the hardest and less redundant pairs. For example, FIG. 9 is a diagram illustrating an example system 900 configured to perform data generation for offline reinforcement learning based on generating positive-negative pairs according to a pairing strategy 908, in accordance with some examples. Given a particular state sₜ, for each negative tactic y⁻ the system can be configured to pick the positive tactic y⁺ with the highest likelihood among those mistakenly ranked lower than y⁻. To avoid the same positive tactic being used (e.g., paired) by too many negative tactics, the pairing strategy 908 can be configured to lower the rank of a respective positive tactic y⁺ in the sorted list each time the positive tactic is picked for pairing with a negative tactic. The system can be configured to consider only positive tactics with lower likelihood when choosing pairs, and the order of the list affects the prioritization of the tactics.

In some cases, for data augmentation, instead of using the original prompt x=(sₜ, pₜ), the system can dynamically generate a new prompt by applying random dropout on the retrieved premises. After choosing a positive tactic y⁺ and generating the augmented prompt x, the tuple (x, y⁺, y⁻) can be added to the dataset D, as described in Pseudocode 1. After the dataset D has been generated, finetuning of the LLM prover model 742 and/or LLM(θ) 825 (e.g., ReProver model, etc.) can be performed using a standard DPO loss, as noted above.

In some cases, the positive-negative pair generation for obtaining the DPO dataset can be performed according to the example of FIG. 9. The term pᵢ represents a prompt, the term cᵢ indicates chosen, and the term rⱼ indicates rejected. Multiple pairing strategies 908 can be implemented, evaluated, and/or considered. For example, the training strategies 908 may include one or more of strategy_zero( ), strategy_random( ), and/or strategy_zero_hard( ), among various others. For example, in strategy_random( ), the pairing strategy 908 may be implemented so that the positive tactics list ( [symbol] ) is randomly shuffled before iterating through the negative tactics ( [symbol] ). For each negative tactic, the first positive tactic is popped from the list, paired with the negative tactic, and then moved to the end of the list. This ensures a random pairing strategy without score comparison.

A pseudocode example associated with an implementation of the pairing strategy (e.g., pairing strategy 908) as strategy_random( ) is illustrated below as Pseudocode 2:

```
Pseudocode 2: Pairing strategy = strategy_random( )
Input: D₁ := { [symbol] ₜ}ₜ, [symbol] ₜ := {sₜ, âₜ, [symbol]  ₜ, [symbol]  ₜ, [symbol]  )
if â not in [symbol]  ₜ, do [symbol]
  ₜ.append(âₜ) [symbol]
  .append(min( [symbol] ₜ) − 1.0) [symbol]
  append(True)
  for state [symbol] ₜ in D₁, do
  ${𝒮}_{t}^{+} ← \{ {a}_{t}^{i} \vert i = 1 … w , if {f}_{t}^{i} is True \}$
  ${𝒮}_{t}^{-} ← \{ {a}_{t}^{i} \vert i = 1 … w , if {f}_{t}^{i} is False \}$
$randomly shuffle {𝒮}_{t}^{+}$
preference_data_list ← [ ] ## Initialize preference_data_list as empty
$if {𝒮}_{t}^{-} is not empty , do$
  $for each {a}_{t}^{-} in {𝒮}_{t}^{-} , do$
    initialize data_dict as None
    $pop the first {a}_{t}^{+} from {𝒮}_{t}^{+}$
      ## Data augmentation to the input prompt: add retrieved
      premises with dropout:
get_dynamic_prompt( )
    data_dict ← {prompt: get_dynamic_prompt(sₜ,
$retrieved\_premises ) , chosen : {a}_{t}^{+} , rejectect : {a}_{t}^{-} \}$
    $move {a}_{t}^{+} to the end of {𝒮}_{t}^{+}$
        if data_dict is not None, do
            preference_data_list.append(data_dict)
preference_data_ex ← {expanded_sample:
preference_data_list[:max_pairs_per_sample]}
return preference_data_ex
```

In some examples, the input D₁ corresponds to the input D₁ 902 of FIG. 9. The return of preference_data_ex can correspond to the preference dataset D₂ 904 of FIG. 9.

A pseudocode example associated with an implementation of the pairing strategy (e.g., pairing strategy 908) as strategy_zero( ) is illustrated below as Pseudocode 3. In strategy_zero( ) implementations of the pairing strategy 908, the system iterates through the positive feedback tactics for each negative feedback tactic, and compares the scores of the negative and positive tactics. If the score of the negative tactic is greater than or equal to the score of the positive tactic, a data dictionary is created with the prompt, the chosen positive tactic, and the rejected negative tactic. The used positive tactic is moved to the end of the list for pairing again if needed.

```
Pseudocode 3: Pairing strategy = strategy_zero( )
Input: D₁ := { [symbol] ₜ}ₜ, [symbol]  ₜ := {sₜ, âₜ, [symbol] ₜ, [symbol]  ₜ, [symbol]  )
if âₜ not in [symbol]  ₜ, do [symbol]
  ₜ.append(âₜ) [symbol]
  ₜ.append(min( [symbol] ₜ) − 1.0) [symbol]
  append(True)
for state [symbol]  ₜ in D₁, do
  ${𝒮}_{t}^{+} ← \{ {a}_{t}^{i} \vert i = 1 … w , if {f}_{t}^{i} is True \}$
  ${𝒮}_{t}^{-} ← \{ {a}_{t}^{i} \vert i = 1 … w , if {f}_{t}^{i} is False \}$
preference_data_list ← [ ] ## Initialize preference_data_list as empty
$if {𝒮}_{t}^{-} is not empty , do$
  $for each {a}_{t}^{-} in {𝒮}_{t}^{-} , do$
    initialize data_dict as None
    $for each {a}_{t}^{+} in {𝒮}_{t}^{+} , do$
      $if {r}_{t}^{-} : score ( {a}_{t}^{-} ) \geq {r}_{t}^{+} : score ( {a}_{t}^{+} ) , do \#\# score ( {a}_{t}^{-} ) \geq score ( {a}_{t}^{+} )$
        ## Data augmentation to the input prompt:
        add retrieved premises with dropout:
get_dynamic_prompt( )
        data_dict ← (prompt: get_dynamic_prompt(sₜ, retrieved_
$premises ) , chosen : {a}_{t}^{+} , rejected : {a}_{t}^{-} \}$
        $move {a}_{t}^{+} to the end of {𝒮}_{t}^{+}$
        break loop
if data_dict is not None, do
    preference_data_list.append(data_dict)
preference_data_ex ← {expanded_sample:
preference_data_list[:max_pairs_per_sample]}
return preference_data_ex
```

In another illustrative example, a pseudocode example associated with an implementation of the pairing strategy (e.g., pairing strategy 908) as strategy_zero_hard( ) is illustrated below as Pseudocode 4. In strategy_zero_hard( ) implementations of the pairing strategy 908, reverse positive tactics can be used to reverse the list of positive feedback tactics so positive tactics with the lowest scores are at the beginning of the list. For each negative feedback tactic, the pairing strategy 908 iterates through the positive feedback tactics and compares the scores of the negative and positive tactics. If the score of the negative tactic is greater than or equal to the score of the positive tactic, a data dictionary is created with the prompt, the chosen positive tactic, and the rejected negative tactic. The used positive tactic is moved to the end of the list to be paired again if needed.

```
Pseudocode 4: Pairing strategy = strategy_zero_hard( )
Input: D₁ := { [symbol] ₜ}ₜ, [symbol] ₜ := {sₜ, âₜ, [symbol] ₜ, [symbol] ₜ, [symbol] ₜ}
if âₜ not in [symbol] ₜ, do [symbol]
ₜ append(âₜ) [symbol]
ₜ.append(min( [symbol] ₜ) − 1.0) [symbol]
.append(True)
for state [symbol] ₜ in D₁, do
${𝒮}_{t}^{+} ← \{ {a}_{t}^{i} \vert i = 1 … w , if {f}_{t}^{i} is True \}$
${𝒮}_{t}^{-} ← \{ {a}_{t}^{i} \vert i = 1 … w , if {f}_{t}^{i} is False \}$
${𝒮}_{t}^{+} . reverse ( ) \#\# Reverse the positive tactic list that it is sorted in$
increasing order of the scores
preference_data_list ← [ ] ## Initialize preference_data_list as empty
$if {𝒮}_{t}^{-} is not empty , do$
  $for each {a}_{t}^{-} in {𝒮}_{t}^{-} , do$
    initialize data_dict as None
    $for each {a}_{t}^{-} in {𝒮}_{t}^{-} , do$
      $if {r}_{t}^{-} : score ( {a}_{t}^{-} ) \geq {r}_{t}^{+} : score ( {a}_{t}^{+} ) , do \#\# score ( {a}_{t}^{-} ) \geq score ( {a}_{t}^{+} )$
        ## Data augmentation to the input prompt: add retrieved
premises with dropout: get_dynamic_prompt( )
        data_dict ← (prompt: get_dynamic_prompt(sₜ, retrieved_
$premises ) , chosen : {a}_{t}^{+} , rejected : {a}_{t}^{-} \}$
        $move {a}_{t}^{+} to the end of {𝒮}_{t}^{+}$
        break loop
if data_dict is not None, do
    preference_data_list.append(data_dict)
preference_data_ex ← {expanded_sample:
preference_data_list[:max_pairs_per_sample]}
return preference_data_ex
```

FIG. 10 is a diagram illustrating an example system 1000 configured to perform data generation for offline reinforcement learning and configured to perform model finetuning using a preference dataset and direct preference optimization (DPO), in accordance with some examples.

In some aspects, the dataset D₀ 1010 of FIG. 10 corresponds to the dataset D₀ 802 of FIG. 8. In some cases, the dataset D₁ 1012 and/or the dataset D₁ 1014 of FIG. 10 corresponds to one or more of the dataset D₁ 804 of FIG. 8, the dataset D₁ 902 and/or 904 of FIG. 9, etc.

In a first step 1003, the system 1000 can obtain feedback information that is used to obtain the dataset D₁ 1012. The dataset D₁ 1012 is refined into the preference dataset D₁ 1014 according to a pairing strategy 1008, for example as noted above with respect to the dataset D₁ 902, pairing strategy 908, and preference dataset D, 904 (respectively).

An LLM(θ) 1025 of FIG. 10 may be the same as or similar to one or more of the LLM 725 of FIG. 7, the LLM(θ) 825 of FIG. 8, etc. In one illustrative example, the DPO trainer 1050 of the system 1000 of FIG. 10 can be used to perform model finetuning by DPO for the LLM(θ) 1025, using the preference dataset 1014 as the DPO preference dataset for the model finetuning. In some cases, a target model associated with the DPO model finetuning is a pre-trained model (e.g., initialize the target model with a pre-trained model). In some examples, a reference model associated with the DPO model finetuning is a pre-trained model (e.g., initialize the target model with the pre-trained model). In some aspects, the final model of the DPO model finetuning of FIG. 10 is a DPO finetuned target model LLM(φ) 1055.

In some examples, the systems and techniques can be used to perform online reinforcement learning for an LLM-based prover system using a simulator-in-the-loop framework. For example, the systems and techniques can be configured to perform online reinforcement learning for the simulator-in-the-loop with an LLM-based prover tool included in the system 700 of FIG. 7, and/or can be configured to perform online reinforcement learning for the example LLM-based prover tool system 800 of FIG. 8, etc. In some cases, offline reinforcement learning techniques can be based on using a pre-trained model to generate and/or collect training data offline, where the collected offline training data is subsequently used to finetune the pre-trained model using reinforcement learning techniques such as DPO. In some examples where offline reinforcement learning techniques are used, the model that is used to generate data (e.g., trajectories, such as the trajectories associated with the beam search 830 of FIG. 8, etc.) does not get updated during the finetuning. In some aspects, online reinforcement learning techniques can be implemented based on performing data generation and model finetuning simultaneously, concurrently, and/or in parallel, etc., where the base model used to generate data (e.g., trajectories, such as the trajectories associated with the beam search 830 of FIG. 8, etc.) is periodically updated and/or refreshed by the intermediate finetuned model of the LLM-based prover tool system 800. For example, when a proof search is terminated after a correct result is found, or a correct result has not yet been found but a search budget has been exhausted (or one or more termination conditions have been met or triggered, etc.), training sampled can be extracted for retraining by the online reinforcement learning techniques.

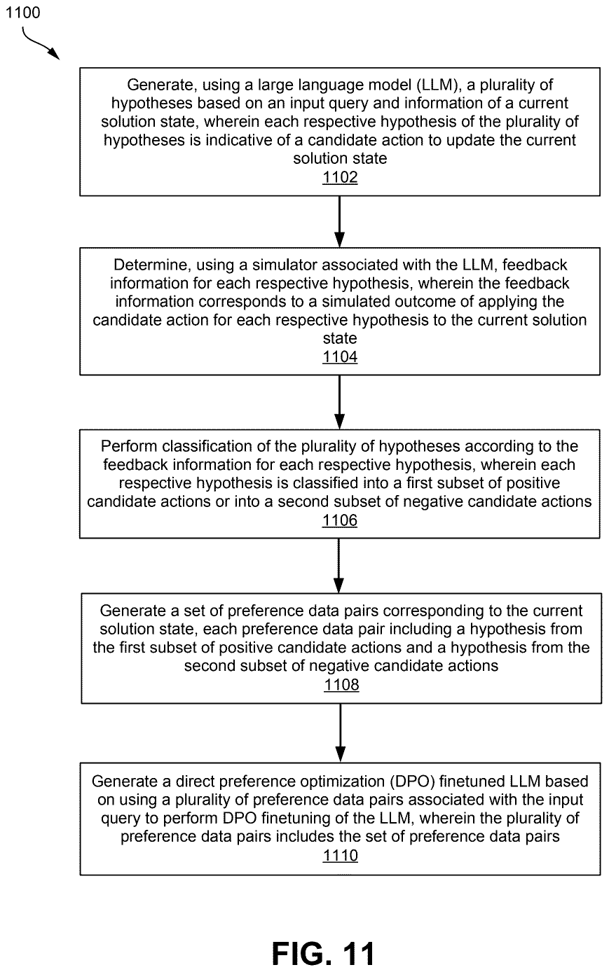

FIG. 11 is a flowchart diagram illustrating an example of a process 1100 for implementing a tool integration framework for agentic AI and/or one or more LLM-based agents. Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence.

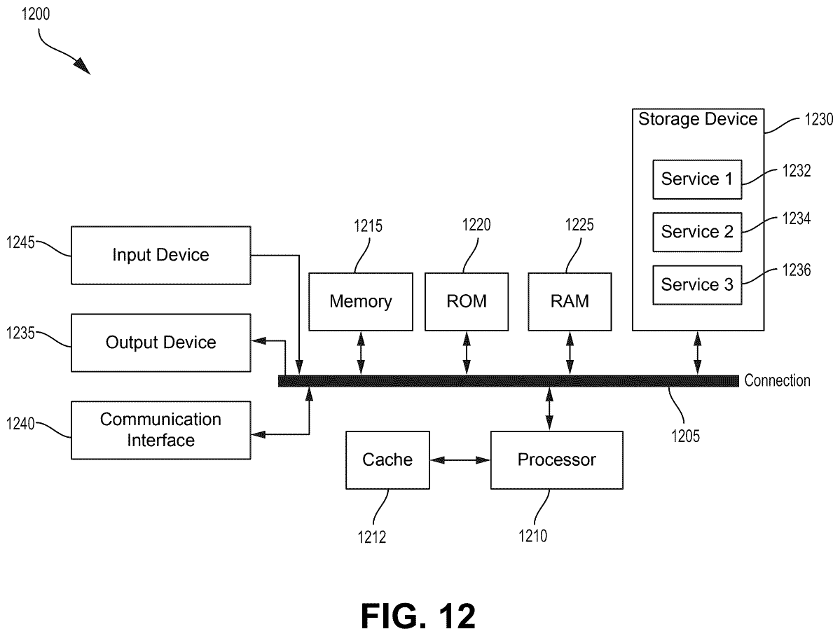

In some examples, the process 1100 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 1100 may be implemented as software components that are executed and run on one or more processors (e.g., processor 1210 of FIG. 12 or other processor(s)). In some examples, the process 1100 can be performed by a machine learning network, including any of the machine learning networks and/or neural networks corresponding to one or more components of various ones of FIGS. 3-10, etc. In some aspects, the process 1100 can be performed by a UE, smartphone, mobile computing device, user computing device, etc. The process 1100 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors (e.g., processor 1210 of FIG. 12, and/or other processor(s)).

At block 1102, an apparatus (or component thereof) can generate, using a large language model (LLM), a plurality of hypotheses based on an input query and information of a current solution state, wherein each respective hypothesis of the plurality of hypotheses is indicative of a candidate action to update the current solution state. For example, the LLM can be the same as or similar to one or more of the LM 325 of FIG. 3, the LM 375 of FIG. 3, the LM 425-1 of FIG. 4, the LM 425-2 of FIG. 4, the tool instructor 540 of FIG. 5A, the tactic generator 590 of FIG. 5B, the LLM agent 675 of FIG. 6, the LLM 725 of FIG. 7, the LLM prover 742 of FIG. 7, the LLM 825 of FIG. 8, the LLM 1025 of FIG. 10, the LLM 1055 of FIG. 10, etc., among various others.

The plurality of hypotheses can correspond to the hypothesis or tool instruction generated by the LM 425-1 of FIG. 4, the final hypothesis simulator response 450 of FIG. 4, the actions (tactics) 630 of FIG. 6, the action 685 of FIG. 6, the tactic 785 of FIG. 7, etc. In some examples, the plurality of hypotheses can correspond to the listing of tactics 832 of FIG. 8 and/or a plurality of tactics associated with a beam search such as the beam search 830 of FIG. 8, etc.

The current solution state can correspond to one or more of the state of the task 510 of FIG. 5A, the state of the proof 560 of FIG. 5B, the states 620 of FIG. 6, the state sₜ 662 of FIG. 6, the state sₜ₊₁ of FIG. 6, the initial state 720 of FIG. 7, the updated state 713 of FIG. 7, the initial state 820 of FIG. 8, the updated state sₜ₊₁ of FIG. 8, etc.

In some cases, the input query is a theorem and the LLM is a pre-trained theorem solver model.

At block 1104, the apparatus (or component thereof) can determine, using a simulator associated with the LLM, feedback information for each respective hypothesis, wherein the feedback information corresponds to a simulated outcome of applying the candidate action for each respective hypothesis to the current solution state. For example, the simulator can be the same as or similar to the simulator 442 of FIG. 4, the tool 545 of FIG. 5A, the math theorem proving tool 595 of FIG. 5B, the tool environment 695 of FIG. 6, the tool environment 748-1 of FIG. 7, the tool environment 848-1 of FIG. 8, the tool environment 848-2 of FIG. 8, etc. In some cases, the feedback information and/or simulated outcome can correspond to one or more of the simulator response final hypothesis 450 of FIG. 4, the state of the task 510 of FIG. 5A, the state of the proof 560 of FIG. 5B, the feedback information 671 of FIG. 6, the feedback information fₜ and/or fₜ₋₁ of FIG. 7, the respective feedback 852

$${ℱ}_{t} := {\{ {f}_{t}^{i} \}}_{i = 1}^{w}$$

for the tactics within the set of tactics

$${𝒜}_{t} := {\{ {a}_{t}^{i} \}}_{i = 1}^{w}$$

of the listing of the plurality of hypothesis/tactics 832 of FIG. 8, etc.

In some examples, to determine the feedback information, the at least one processor is configured to generate, using the LLM, an output prompt indicative of the plurality of hypotheses, wherein the output prompt comprises a simulator tool instruction to configure the simulator. In some cases, the output prompt from the LLM causes the simulator to perform a plurality of simulations from the current solution state to determine the simulated outcome for each respective hypothesis.

In some cases, the feedback information for each respective hypothesis is determined by a reward model associated with the simulator. In some examples. an inner simulator tool interaction loop includes the simulator and the reward model, and an outer solution loop includes the LLM and the inner simulator tool interaction loop. For example, the inner simulator tool interaction loop can correspond to the inner tool interaction loop 440 of FIG. 4, the inner tool interaction loop 760 of FIG. 7, the inner tool interaction loop associated with the beam search 830 of FIG. 8, etc. In some examples, the outer solution loop can correspond to the outer solution loop 410 of FIG. 4, the outer theorem proving loop 710 of FIG. 7, the outer theorem proving loop 810 of FIG. 8, etc.

In some cases, the outer solution loop is configured to iterate through a plurality of solution states for the input query, the plurality of solution states including the current solution state. In some examples, for each iteration of the outer solution loop, the inner simulator tool interaction loop is configured to loop over a plurality of candidate action hypotheses generated by the LLM for a particular solution state of the plurality of solution states. In some cases, the simulator is configured to generate the feedback information for each respective hypothesis based on a tool instruction generated by the LLM. In some examples, the tool instruction is indicative of the respective hypothesis and the current solution state.

At block 1106, the apparatus (or component thereof) can perform classification of the plurality of hypotheses according to the feedback information for each respective hypothesis, wherein each respective hypothesis is classified into a first subset of positive candidate actions or into a second subset of negative candidate actions. For example, the respective feedback information 852 of FIG. 8 can indicate whether each tactic (e.g., action) 832 can be applied successfully (e.g., is valid) or cannot be applied successfully (e.g., is invalid). In some examples, for the listing of listing of w=8 tactics corresponding to the beam search 830 and the listing of tactics (e.g., hypotheses) 832 of FIG. 8, the tool environment 848-1 can determine the feedback set 852 indicating that a first tactic

$${a}_{t}^{1}$$

is not valid for the current state sₜ; a second tactic

$${a}_{t}^{2}$$

is valid for the current state sₜ; a third tactic

$${a}_{t}^{3}$$

is valid for the current state sₜ; a fourth tactic

$${a}_{t}^{4}$$

is not valid for the current state sₜ; a fifth tactic

$${a}_{t}^{5}$$

is valid for the current state sₜ; a sixth tactic

$${a}_{t}^{6}$$

is valid for the current state sₜ; a seventh tactic

$${a}_{t}^{7}$$

is not valid for the current state sₜ; and an eighth tactic

$${a}_{t}^{8}$$

is not valid for the current state sₜ.

In some cases, the feedback information for each respective hypothesis is determined by a reward model associated with the simulator. In some examples, to perform the classification of the plurality of hypotheses according to the feedback information, the at least one processor is configured to determine a corresponding reward for each respective hypothesis based on using the reward model to process a simulated outcome from the simulator for each respective hypothesis.

In some cases, corresponding awards (e.g., including each corresponding reward determined for each respective hypothesis) determined by the reward model for the first subset of positive candidate actions are greater than the corresponding rewards determined by the reward model of the second subset of negative candidate actions. In some examples, the first subset of positive candidate actions comprise valid candidate actions associated with a successful simulated outcome, and wherein the second subset of negative candidate actions comprise candidate actions associated with an unsuccessful simulated outcome.

At block 1108, the apparatus (or component thereof) can generate a set of preference data pairs corresponding to the current solution state, each preference data pair including a hypothesis from the first subset of positive candidate actions and a hypothesis from the second subset of negative candidate actions. For example, the set of preference data pairs can correspond to the preference dataset 904 and pairing strategy 908 of FIG. 9, where the first subset of positive candidate action hypotheses and the second subset of negative candidate action hypotheses are included in the dataset 902 of FIG. 9. In some cases, the set of preference data pairs can correspond to the preference dataset 1014 of FIG. 10 and the pairing strategy 1008 of FIG. 10. The first subset of positive candidate action hypotheses and the second subset of negative candidate action hypotheses can be included in one or more of the dataset 1010 and/or the dataset 1012 of FIG. 10. In some cases, the positive and negative candidate actions can be determined based at least in part on the feedback 1003 of FIG. 10.

At block 1110, the apparatus (or component thereof) can generate a direct preference optimization (DPO) finetuned LLM based on using a plurality of preference data pairs associated with the input query to perform DPO finetuning of the LLM, wherein the plurality of preference data pairs includes the set of preference data pairs. For example, the DPO finetuned LLM can be the same as or similar to the DPO finetuned LLM 1055 of FIG. 10. In some cases, the DPO finetuning of the LLM can correspond to the DPO finetuning of the LLM 1025 to obtain or generate the DPO finetuned LLM 1055 of FIG. 10. In some examples, the DPO finetuned LLM can be generated using the DPO trainer 1050 of FIG. 10. In some cases, the DPO finetuned LLM is trained to perform beam search for a best trajectory candidate action from a respective plurality of candidate actions for each solution state of an input query at inference time.

As noted previously, the processes described herein (e.g., the process 1100 and/or any other process described herein) may be performed by a computing device or apparatus. In some aspects, the process 1100 and/or other technique or process described herein can be performed by a computing system having an architecture according to any of FIGS. 1-10. In another example, the process 1100 and/or other technique or process described herein can be performed by the computing system 1200 shown in FIG. 12. In some examples, the computing device can include a mobile device (e.g., a mobile phone, a tablet computing device, etc.), a wearable device, an extended reality device (e.g., a virtual reality (VR) device, an augmented reality (AR) device, or a mixed reality (MR) device), a personal computer, a laptop computer, a video server, a television, a vehicle (or a computing device of a vehicle), robotic device, and/or any other computing device with the resource capabilities to perform the processes described herein.

In some cases, the computing device or apparatus may include various components, such as one or more input devices, one or more output devices, one or more processors, one or more microprocessors, one or more microcomputers, one or more transmitters, receivers or combined transmitter-receivers (e.g., referred to as transceivers), one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), and/or other suitable electronic circuits), and/or can include and/or be implemented using computer software, firmware, or any combination thereof, to perform the various operations described herein.

The processes described herein may be illustrated or described as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 illustrates an example computing device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random access memory (RAM) 1225, to processor 1210.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other modules can control or be configured to control processor 1210 to perform various actions. Other computing device memory 1215 may be available for use as well. Memory 1215 can include multiple different types of memory with different performance characteristics. Processor 1210 can include any general purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing device architecture 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules are contemplated. Storage device 1230 can be connected to the computing device connection 1205. In some aspects, a hardware module that performs a particular function can include the software component stored in a computer-readable medium in connection with the necessary hardware components, such as processor 1210, connection 1205, output device 1235, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices.

Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus comprising: at least one memory; and at least one processor coupled to the at least one memory and configured to: generate, using a large language model (LLM), a plurality of hypotheses based on an input query and information of a current solution state, wherein each respective hypothesis of the plurality of hypotheses is indicative of a candidate action to update the current solution state; determine, using a simulator associated with the LLM, feedback information for each respective hypothesis, wherein the feedback information corresponds to a simulated outcome of applying the candidate action for each respective hypothesis to the current solution state; perform classification of the plurality of hypotheses according to the feedback information for each respective hypothesis, wherein each respective hypothesis is classified into a first subset of positive candidate actions or into a second subset of negative candidate actions; generate a set of preference data pairs corresponding to the current solution state, each preference data pair including a hypothesis from the first subset of positive candidate actions and a hypothesis from the second subset of negative candidate actions; and generate a direct preference optimization (DPO) finetuned LLM based on using a plurality of preference data pairs associated with the input query to perform DPO finetuning of the LLM, wherein the plurality of preference data pairs includes the set of preference data pairs.
Aspect 2. The apparatus of Aspect 1, wherein, to determine the feedback information, the at least one processor is configured to: generate, using the LLM, an output prompt indicative of the plurality of hypotheses, wherein the output prompt comprises a simulator tool instruction to configure the simulator.
Aspect 3. The apparatus of Aspect 2, wherein the output prompt from the LLM causes the simulator to perform a plurality of simulations from the current solution state to determine the simulated outcome for each respective hypothesis.
Aspect 4. The apparatus of any of Aspects 1 to 3, wherein the feedback information for each respective hypothesis is determined by a reward model associated with the simulator.
Aspect 5. The apparatus of Aspect 4, wherein, to perform the classification of the plurality of hypotheses according to the feedback information, the at least one processor is configured to: determine a corresponding reward for each respective hypothesis based on using the reward model to process a simulated outcome from the simulator for each respective hypothesis.
Aspect 6. The apparatus of Aspect 5, wherein corresponding awards determined by the reward model for the first subset of positive candidate actions are greater than the corresponding rewards determined by the reward model of the second subset of negative candidate actions.
Aspect 7. The apparatus of any of Aspects 5 to 6, wherein the first subset of positive candidate actions comprise valid candidate actions associated with a successful simulated outcome, and wherein the second subset of negative candidate actions comprise candidate actions associated with an unsuccessful simulated outcome.
Aspect 8. The apparatus of any of Aspects 4 to 7, wherein: an inner simulator tool interaction loop includes the simulator and the reward model; and an outer solution loop includes the LLM and the inner simulator tool interaction loop.
Aspect 9. The apparatus of Aspect 8, wherein: the outer solution loop is configured to iterate through a plurality of solution states for the input query, the plurality of solution states including the current solution state; and for each iteration of the outer solution loop, the inner simulator tool interaction loop is configured to loop over a plurality of candidate action hypotheses generated by the LLM for a particular solution state of the plurality of solution states.
Aspect 10. The apparatus of any of Aspects 1 to 9, wherein the simulator is configured to generate the feedback information for each respective hypothesis based on a tool instruction generated by the LLM, and wherein the tool instruction is indicative of the respective hypothesis and the current solution state.
Aspect 11. The apparatus of any of Aspects 1 to 10, wherein the DPO finetuned LLM is trained to perform beam search for a best trajectory candidate action from a respective plurality of candidate actions for each solution state of an input query at inference time.
Aspect 12. The apparatus of any of Aspects 1 to 11, wherein the input query is a theorem and the LLM is a pre-trained theorem solver model.
Aspect 13. A method comprising: generating, using a large language model (LLM), a plurality of hypotheses based on an input query and information of a current solution state, wherein each respective hypothesis of the plurality of hypotheses is indicative of a candidate action to update the current solution state; determining, using a simulator associated with the LLM, feedback information for each respective hypothesis, wherein the feedback information corresponds to a simulated outcome of applying the candidate action for each respective hypothesis to the current solution state; performing classification of the plurality of hypotheses according to the feedback information for each respective hypothesis, wherein each respective hypothesis is classified into a first subset of positive candidate actions or into a second subset of negative candidate actions; generating a set of preference data pairs corresponding to the current solution state, each preference data pair including a hypothesis from the first subset of positive candidate actions and a hypothesis from the second subset of negative candidate actions; and generating a direct preference optimization (DPO) finetuned LLM based on using a plurality of preference data pairs associated with the input query to perform DPO finetuning of the LLM, wherein the plurality of preference data pairs includes the set of preference data pairs.
Aspect 14. The method of Aspect 13, wherein determining the feedback information comprises: generating, using the LLM, an output prompt indicative of the plurality of hypotheses, wherein the output prompt comprises a simulator tool instruction to configure the simulator.
Aspect 15. The method of Aspect 14, wherein the output prompt from the LLM causes the simulator to perform a plurality of simulations from the current solution state to determine the simulated outcome for each respective hypothesis.
Aspect 16. The method of any of Aspects 13 to 15, wherein the feedback information for each respective hypothesis is determined by a reward model associated with the simulator.
Aspect 17. The method of Aspect 16, wherein performing the classification of the plurality of hypotheses according to the feedback information includes: determining a corresponding reward for each respective hypothesis based on using the reward model to process a simulated outcome from the simulator for each respective hypothesis.
Aspect 18. The method of Aspect 17, wherein corresponding awards determined by the reward model for the first subset of positive candidate actions are greater than the corresponding rewards determined by the reward model of the second subset of negative candidate actions.
Aspect 19. The method of any of Aspects 17 to 18, wherein the first subset of positive candidate actions comprise valid candidate actions associated with a successful simulated outcome, and wherein the second subset of negative candidate actions comprise candidate actions associated with an unsuccessful simulated outcome.
Aspect 20. The method of any of Aspects 16 to 19, wherein: an inner simulator tool interaction loop includes the simulator and the reward model; and an outer solution loop includes the LLM and the inner simulator tool interaction loop.
Aspect 21. The method of Aspect 20, wherein: the outer solution loop is configured to iterate through a plurality of solution states for the input query, the plurality of solution states including the current solution state; and for each iteration of the outer solution loop, the inner simulator tool interaction loop is configured to loop over a plurality of candidate action hypotheses generated by the LLM for a particular solution state of the plurality of solution states.
Aspect 22. The method of any of Aspects 13 to 21, wherein the simulator is configured to generate the feedback information for each respective hypothesis based on a tool instruction generated by the LLM, and wherein the tool instruction is indicative of the respective hypothesis and the current solution state.
Aspect 23. The method of any of Aspects 13 to 22, wherein the DPO finetuned LLM is trained to perform beam search for a best trajectory candidate action from a respective plurality of candidate actions for each solution state of an input query at inference time.
Aspect 24. The method of any of Aspects 13 to 23, wherein the input query is a theorem and the LLM is a pre-trained theorem solver model.
Aspect 25. A non-transitory computer-readable medium comprising instructions that, when executed by at least one processor, cause the at least one processor to: generate, using a large language model (LLM), a plurality of hypotheses based on an input query and information of a current solution state, wherein each respective hypothesis of the plurality of hypotheses is indicative of a candidate action to update the current solution state; determine, using a simulator associated with the LLM, feedback information for each respective hypothesis, wherein the feedback information corresponds to a simulated outcome of applying the candidate action for each respective hypothesis to the current solution state; perform classification of the plurality of hypotheses according to the feedback information for each respective hypothesis, wherein each respective hypothesis is classified into a first subset of positive candidate actions or into a second subset of negative candidate actions; generate a set of preference data pairs corresponding to the current solution state, each preference data pair including a hypothesis from the first subset of positive candidate actions and a hypothesis from the second subset of negative candidate actions; and generate a direct preference optimization (DPO) finetuned LLM based on using a plurality of preference data pairs associated with the input query to perform DPO finetuning of the LLM, wherein the plurality of preference data pairs includes the set of preference data pairs.
Aspect 26. The non-transitory computer-readable medium of Aspect 25, wherein, to determine the feedback information, the instructions cause the at least one processor to: generate, using the LLM, an output prompt indicative of the plurality of hypotheses, wherein the output prompt comprises a simulator tool instruction to configure the simulator.
Aspect 27. The non-transitory computer-readable medium of Aspect 26, wherein the output prompt from the LLM causes the simulator to perform a plurality of simulations from the current solution state to determine the simulated outcome for each respective hypothesis.
Aspect 28. The non-transitory computer-readable medium of any of Aspects 25 to 27, wherein the feedback information for each respective hypothesis is determined by a reward model associated with the simulator.
Aspect 29. The non-transitory computer-readable medium of Aspect 28, wherein, to perform the classification of the plurality of hypotheses according to the feedback information, the instructions cause the at least one processor to: determine a corresponding reward for each respective hypothesis based on using the reward model to process a simulated outcome from the simulator for each respective hypothesis.
Aspect 30. The non-transitory computer-readable medium of Aspect 29, wherein corresponding awards determined by the reward model for the first subset of positive candidate actions are greater than the corresponding rewards determined by the reward model of the second subset of negative candidate actions.
Aspect 31. The non-transitory computer-readable medium of any of Aspects 29 to 30, wherein the first subset of positive candidate actions comprise valid candidate actions associated with a successful simulated outcome, and wherein the second subset of negative candidate actions comprise candidate actions associated with an unsuccessful simulated outcome.
Aspect 32. The non-transitory computer-readable medium of any of Aspects 28 to 31, wherein: an inner simulator tool interaction loop includes the simulator and the reward model; and an outer solution loop includes the LLM and the inner simulator tool interaction loop.
Aspect 33. The non-transitory computer-readable medium of Aspect 32, wherein: the outer solution loop is configured to iterate through a plurality of solution states for the input query, the plurality of solution states including the current solution state; and for each iteration of the outer solution loop, the inner simulator tool interaction loop is configured to loop over a plurality of candidate action hypotheses generated by the LLM for a particular solution state of the plurality of solution states.
Aspect 34. The non-transitory computer-readable medium of any of Aspects 25 to 33, wherein the simulator is configured to generate the feedback information for each respective hypothesis based on a tool instruction generated by the LLM, and wherein the tool instruction is indicative of the respective hypothesis and the current solution state.
Aspect 35. The non-transitory computer-readable medium of any of Aspects 25 to 34, wherein the DPO finetuned LLM is trained to perform beam search for a best trajectory candidate action from a respective plurality of candidate actions for each solution state of an input query at inference time.
Aspect 36. The non-transitory computer-readable medium of any of Aspects 25 to 35, wherein the input query is a theorem and the LLM is a pre-trained theorem solver model.
Aspect 37. A non-transitory computer-readable storage medium comprising instructions stored thereon which, when executed by at least one processor, causes the at least one processor to perform operations according to any of Aspects 13 to 24.
Aspect 38. An apparatus comprising one or more means for performing operations according to any of Aspects 13 to 24.

What is claimed is:

1. An apparatus comprising:
at least one memory; and
at least one processor coupled to the at least one memory and configured to:
generate, using a large language model (LLM), a plurality of hypotheses based on an input query and information of a current solution state, wherein each respective hypothesis of the plurality of hypotheses is indicative of a candidate action to update the current solution state;
determine, using a simulator associated with the LLM, feedback information for each respective hypothesis, wherein the feedback information corresponds to a simulated outcome of applying the candidate action for each respective hypothesis to the current solution state;
perform classification of the plurality of hypotheses according to the feedback information for each respective hypothesis, wherein each respective hypothesis is classified into a first subset of positive candidate actions or into a second subset of negative candidate actions;
generate a set of preference data pairs corresponding to the current solution state, each preference data pair including a hypothesis from the first subset of positive candidate actions and a hypothesis from the second subset of negative candidate actions; and
generate a direct preference optimization (DPO) finetuned LLM based on using a plurality of preference data pairs associated with the input query to perform DPO finetuning of the LLM, wherein the plurality of preference data pairs includes the set of preference data pairs.

2. The apparatus of claim 1, wherein, to determine the feedback information, the at least one processor is configured to:
generate, using the LLM, an output prompt indicative of the plurality of hypotheses, wherein the output prompt comprises a simulator tool instruction to configure the simulator.

3. The apparatus of claim 2, wherein the output prompt from the LLM causes the simulator to perform a plurality of simulations from the current solution state to determine the simulated outcome for each respective hypothesis.

4. The apparatus of claim 1, wherein the feedback information for each respective hypothesis is determined by a reward model associated with the simulator.

5. The apparatus of claim 4, wherein, to perform the classification of the plurality of hypotheses according to the feedback information, the at least one processor is configured to:
determine a corresponding reward for each respective hypothesis based on using the reward model to process a simulated outcome from the simulator for each respective hypothesis.

6. The apparatus of claim 5, wherein corresponding awards determined by the reward model for the first subset of positive candidate actions are greater than the corresponding rewards determined by the reward model of the second subset of negative candidate actions.

7. The apparatus of claim 5, wherein the first subset of positive candidate actions comprise valid candidate actions associated with a successful simulated outcome, and wherein the second subset of negative candidate actions comprise candidate actions associated with an unsuccessful simulated outcome.

8. The apparatus of claim 4, wherein:
an inner simulator tool interaction loop includes the simulator and the reward model; and
an outer solution loop includes the LLM and the inner simulator tool interaction loop.

9. The apparatus of claim 8, wherein:
the outer solution loop is configured to iterate through a plurality of solution states for the input query, the plurality of solution states including the current solution state; and
for each iteration of the outer solution loop, the inner simulator tool interaction loop is configured to loop over a plurality of candidate action hypotheses generated by the LLM for a particular solution state of the plurality of solution states.

10. The apparatus of claim 1, wherein the simulator is configured to generate the feedback information for each respective hypothesis based on a tool instruction generated by the LLM, and wherein the tool instruction is indicative of the respective hypothesis and the current solution state.

11. The apparatus of claim 1, wherein the DPO finetuned LLM is trained to perform beam search for a best trajectory candidate action from a respective plurality of candidate actions for each solution state of an input query at inference time.

12. The apparatus of claim 1, wherein the input query is a theorem and the LLM is a pre-trained theorem solver model.

13. A method comprising:
generating, using a large language model (LLM), a plurality of hypotheses based on an input query and information of a current solution state, wherein each respective hypothesis of the plurality of hypotheses is indicative of a candidate action to update the current solution state;
determining, using a simulator associated with the LLM, feedback information for each respective hypothesis, wherein the feedback information corresponds to a simulated outcome of applying the candidate action for each respective hypothesis to the current solution state;
performing classification of the plurality of hypotheses according to the feedback information for each respective hypothesis, wherein each respective hypothesis is classified into a first subset of positive candidate actions or into a second subset of negative candidate actions;
generating a set of preference data pairs corresponding to the current solution state, each preference data pair including a hypothesis from the first subset of positive candidate actions and a hypothesis from the second subset of negative candidate actions; and
generating a direct preference optimization (DPO) finetuned LLM based on using a plurality of preference data pairs associated with the input query to perform DPO finetuning of the LLM, wherein the plurality of preference data pairs includes the set of preference data pairs.

14. The method of claim 13, wherein determining the feedback information comprises:
generating, using the LLM, an output prompt indicative of the plurality of hypotheses, wherein the output prompt comprises a simulator tool instruction to configure the simulator.

15. The method of claim 14, wherein the output prompt from the LLM causes the simulator to perform a plurality of simulations from the current solution state to determine the simulated outcome for each respective hypothesis.

16. The method of claim 13, wherein the feedback information for each respective hypothesis is determined by a reward model associated with the simulator.

17. The method of claim 16, wherein performing the classification of the plurality of hypotheses according to the feedback information includes:
determining a corresponding reward for each respective hypothesis based on using the reward model to process a simulated outcome from the simulator for each respective hypothesis.

18. The method of claim 17, wherein corresponding awards determined by the reward model for the first subset of positive candidate actions are greater than the corresponding rewards determined by the reward model of the second subset of negative candidate actions.

19. The method of claim 17, wherein the first subset of positive candidate actions comprise valid candidate actions associated with a successful simulated outcome, and wherein the second subset of negative candidate actions comprise candidate actions associated with an unsuccessful simulated outcome.

20. A non-transitory computer-readable medium comprising instructions that, when executed by at least one processor, cause the at least one processor to:
generate, using a large language model (LLM), a plurality of hypotheses based on an input query and information of a current solution state, wherein each respective hypothesis of the plurality of hypotheses is indicative of a candidate action to update the current solution state;
determine, using a simulator associated with the LLM, feedback information for each respective hypothesis, wherein the feedback information corresponds to a simulated outcome of applying the candidate action for each respective hypothesis to the current solution state;
perform classification of the plurality of hypotheses according to the feedback information for each respective hypothesis, wherein each respective hypothesis is classified into a first subset of positive candidate actions or into a second subset of negative candidate actions;
generate a set of preference data pairs corresponding to the current solution state, each preference data pair including a hypothesis from the first subset of positive candidate actions and a hypothesis from the second subset of negative candidate actions; and
generate a direct preference optimization (DPO) finetuned LLM based on using a plurality of preference data pairs associated with the input query to perform DPO finetuning of the LLM, wherein the plurality of preference data pairs includes the set of preference data pairs.
